(19) United States
(12) Patent Application Publication
(10) Pub. No.: US 2005/0118363 A1
(43) Pub. Date: Jun. 2, 2005

(54) Heat transfer recording material

(75) Inventors: Junichi Fujimori, Sizuoka (JP); Shinichi Yoshinari, Sizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/948,286

(22) Filed: Sep. 24, 2004

(30) Foreign Application Priority Data
Sep. 26, 2003 (JP) P.2003-335401
Sep. 26, 2003 (JP) P.2003-335450

(51) Int. Cl. B41M 5/40

(52) U.S. Cl. 428/32.81

(57) ABSTRACT

To provide a white heat transfer recording material having a high hiding power and a high recording sensitivity, and a heat transfer recording material which shows no hue change after image formation and which can provide a hue equal to that of printed matters, can provide a high sensitivity and can be used for package and print color proof, the heat transfer recording material includes a support; a light-to-heat conversion layer containing a light-to-heat conversion material and a matting agent having an average particle diameter of more than 0.5 μm and less than 5 μm; and an image-forming layer containing titanium oxide, or the heat transfer recording material includes a light-to-heat conversion layer having a absorbance of 1.0 to 2.0 at a peak wavelength of laser light; and a ratio of the absorbance to a thickness of the light-to-heat conversion layer of 2.5 to 3.2.

### BACKGROUND OF THE INVENTION

1. Field of the Invention

The present invention relates to a heat transfer recording material for forming a high resolution image using laser light. More particularly, the present invention relates to a heat transfer recording material useful in the preparation of a color proof (DDCP: direct digital color proof) or mask image in the art of printing from a digital image signal by laser recording.

2. Background Art

In graphic art, in order to check to see if there are errors made at the color separation step or if there is a necessity for color correction before final printing (actual printing job), a color proof is prepared from the color separation film. A color proof is required to realize a high resolution capable of attaining a high reproducibility of half tone image and provide properties such as high process stability. In order to obtain a color proof approximated by actual printed matters, the color proof is preferably made of a base material and pigment (colorant) which are used in the actual printed matters. As a process for the preparation of the color proof there is preferably used a dry process free from developer.

As a color proof preparation method in a dry process, there has been developed a recording system involving the preparation of a color proof directly from a digital signal with the spread of electronic system in prepress step (art of prepress). Such an electronic system is particularly intended to prepare a color proof having high image quality and normally acts to reproduce a halftone image having a density of 150 lines/inch. In order to record the color proof having high image quality from a digital signal, a laser capable of emitting laser light which can be modulated by the digital signal and can be finely converged after recording is used as a recording head. To this end, it is necessary to develop a recording material having a high recording sensitivity with respect to laser light and a high resolution that allows the reproduction of fine dots.

As recording materials for use in transfer image formation method using laser light, there have been disclosed a hot-melt transfer sheet comprising sequentially on a support a light-to-heat conversion layer which absorbs laser light to generate heat and an image-forming layer having a pigment dispersed in a hot-melt component such as wax and binder (see JP-A-5-58045), and a heat transfer sheet for an ablation process, the heat transfer sheet comprising sequentially on a support a light-to-heat conversion layer containing a light-to-heat conversion material, a heat peeling layer having a very small thickness (0.03 to 0.3 μm) and an image-forming layer containing a colorant (see JP-A-6-219052).

These image formation processes are advantageous in that as an image-receiving sheet material there can be used a final printing paper provided with an image-receiving layer (adhesive layer) and images having different colors can be sequentially transferred onto the image-receiving sheet to easily obtain a multi-color image. These image formation processes are useful in the preparation of color proofs (DDCP: direct digital color proof) in A2 and B2 sizes.

However, during image recording using laser light, infrared-absorbing dyes incorporated in the light-to-heat conversion layer or decomposition products thereof can move to the image-forming layer, making the color of the image-forming layer thus transferred different from the original color of the image-forming layer. This coloration is remarkable particularly with a white image-forming layer used in the art of package. This trouble drastically mars the commercial value of the products. Further, when the image thus formed is exposed indoor or outdoor, the infrared-absorbing dyes or decomposition products thereof in the image-forming layer are further subject to fading, macking it impossible to obtain a stable hue.

In order to avoid these troubles, carbon black, which undergoes no heat decomposition, has been occasionally used as a light-to-heat conversion material. However, the use of carbon black is disadvantageous in that a sufficient sensitivity cannot be obtained and when the light-to-heat conversion layer containing carbon black is destroyed by heat, carbon black is transferred to the recorded image, causing the change of hue of the image. It has been therefore desired to develop a means capable of minimizing coloration even when as the light-to-heat conversion material there is used an organic dye such as infrared-absorbing dye and obtaining a high sensitivity.

### SUMMARY OF THE INVENTION

In order to solve the aforementioned problems, the invention has aims as set forth below:

1) To provide a heat transfer recording material having a high recording sensitivity capable of forming a white image having a high hiding power;

2) To provide a heat transfer recording material capable of forming a transfer image having a sharp hue characteristic of pigment colorant, i.e., hue equal to that of printed matters;

3) To provide a heat transfer recording material having little change of hue of formed image, particularly due to exposure to light;

4) To provide a heat transfer recording material which can be transferred to final printing paper such as art (coated) paper, matted paper and finely-coated paper or a transparent plastic film for use in package or the like and allows reproduction of delicate texture or accurate white (high key area); and

5) To provide a heat transfer recording material which shows a good image quality even when subjected to laser recording using laser light, which is a multi-beam, at a high energy, can be difficultly affected by foreign matters such as dust, shows a good in-plane uniformity and allows formation of an image having a stable transfer density.

The aforementioned problems can be solved by the following means:

1) A heat transfer recording material, which comprises:
a support;
a light-to-heat conversion layer comprising a light-to-heat conversion material and a matting agent, the matting agent having an average particle diameter of more than 0.5 μm and less than 5 μm; and
an image-forming layer comprising a titanium oxide.

2) The heat transfer recording material according to item 1), wherein the matting agent comprises a particulate silicone resin.

3) The heat transfer recording material according to item 1) or 2), wherein the titanium oxide is a rutile titanium oxide.

4) The heat transfer recording material according to any one of items 1) to 3), wherein the titanium oxide has a surface coated with an alumina and a silica.

5) The heat transfer recording material according to any one of items 1) to 4), wherein the light-to-heat conversion layer comprises at least one of a vinyl pyrrolidone homopolymer and a vinyl pyrrolidone copolymer.

6) The heat transfer recording material according to item 5), wherein the vinyl pyrrolidone copolymer comprises a vinyl pyrrolidone moiety in an amount of 50 mol-% or more

7) The heat transfer recording material according to item 5) or 6), wherein the vinyl pyrrolidone copolymer is a copolymer of a vinyl pyrrolidone and a styrene.

8) The heat transfer recording material according to any one of items 1) to 7), wherein the light-to-heat conversion layer comprises a polymideimide resin.

9) The heat transfer recording material according to any one of items 1) to 8), wherein the light-to-heat conversion layer has a absorbance A of from 1.0 to 2.0 at a wavelength of 808 nm, and the light-to-heat conversion layer has a ratio A/X of the absorbance A to a thickness X of the light-to-heat conversion layer of from 2.5 to 3.2.

10) The heat transfer recording material according to any one of items 1) to 9), wherein the light-to-heat conversion material is an infrared-absorbing dye represented by formula (1): 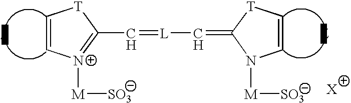
wherein Z represents an atomic group which forms a benzene ring, naphthalene ring or heterocyclic aromatic ring;
T represents —O—, —S—, —Se—, —N(R¹)—, —C(R²)(R³)— or —C(R⁴)═C(R⁵)—, wherein R¹, R² and R³ each independently represents an alkyl group, an alkenyl group or an aryl group; and R⁴ and R⁵ each independently represents a hydrogen atom, a halogen atom, an alkyl group, an aryl group, an alkoxy group, an aryloxy group, a carboxyl group, an acyl group, an acylamino group, a carbamoyl group, a sulfamoyl group or a sulfonamide group;
L represents a trivalent connecting group; wherein 5 or 7 methine groups are connected with a conjugated double bond;
M represents a divalent connecting group; and
X⁺ represents a cation.

11) The heat transfer recording material according to item 10, wherein the infrared-absorbing dye is a dye represented by formula (2):

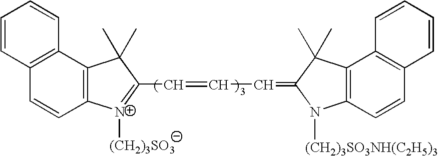

12) The heat transfer recording material according to any one of items 1) to 11), wherein the image-forming layer comprises a fluorescent brightener.

13) A heat transfer recording material, which comprises: a support; a light-to-heat conversion layer comprising a light-to-heat conversion material, the light-to-heat conversion material absorbing a laser light to generate a heat; and an image-forming layer,
the light-to-heat conversion layer has a absorbance A of from 1.0 to 2.0 at a peak wavelength of the laser light, and the light-to-heat conversion layer has a ratio A/X of the absorbance A to a thickness X of the light-to-heat conversion layer of from 2.5 to 3.2.

14) The heat transfer recording material according to item 13), wherein the light-to-heat conversion material comprises an infrared-absorbing dye represented by formula (1): 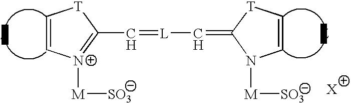
wherein Z represents an atomic group which forms a benzene ring, naphthalene ring or heterocyclic aromatic ring;
T represents —O—, —S—, —Se—, —N(R¹)—, —C(R²)(R³)— or —C(R⁴)═C(R⁵)—, wherein R¹, R² and R³ each independently represents an alkyl group, an alkenyl group or an aryl group; and R⁴ and R⁵ each independently represents a hydrogen atom, a halogen atom, an alkyl group, an aryl group, an alkoxy group, an aryloxy group, a carboxyl group, an acyl group, an acylamino group, a carbamoyl group, a sulfamoyl group or a sulfonamide group;
L represents a trivalent connecting group, wherein 5 or 7 methine groups are connected with a conjugated double bond;
M represents a divalent connecting group; and
X⁺ represents a cation.

15) The heat transfer recording material according to item 14), wherein the infrared-absorbing dye is a dye represented by formula (2):

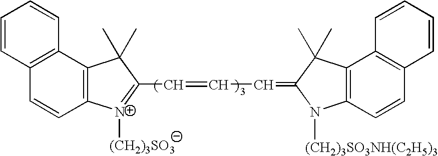

16) The heat transfer recording material according to any one of items 13) to 15), wherein the image-forming layer comprises a titanium oxide (TiO₂) as a white pigment.

17) The heat transfer recording material according to item 16), wherein the titanium oxide is a rutile titanium oxide.

18) The heat transfer recording material according to item 16) or 17), wherein the titanium oxide has a surface coated with an alumina and a silica.

19. The heat transfer recording material according to any one of items 13) to 18), wherein the peak wavelength of the laser light is 808 nm.

The invention can provide a heat transfer recording material capable of forming a white image having a high hiding power, a high whiteness with little yellow tint, little fading due to indoor exposure and a good quality at a good recording sensitivity.

In accordance with the invention, the ratio (A/X) of the absorbance A of the light-to-heat conversion layer to the thickness X (μm) of the light-to-heat conversion layer is predetermined to a specific range, making it possible to provide a heat transfer recording material which is subject to minimized fading due to the decomposition products of the light-to-heat conversion material, can form a high quality image and exhibits a high sensitivity during recording.

Further, in accordance with the invention, a white heat transfer recording material containing a white pigment in its image-forming layer and other color heat transfer recording materials can provide a multi-color image-receiving material useful in the formation of an image on package, etc. By providing a white heat transfer recording material as a white ground when a multi-color image is transferred onto a final receiving material such as transparent plastic film, the multi-color image thus formed on the white ground can be provided with a high sharpness and a hue identical to the original hue.

### BRIEF DESCRIPTION OF THE DRAWING

FIGS. 1A-1C show a diagram illustrating the outline of the mechanism of image formation by thin film heat transfer using laser.

### DETAILED DESCRIPTION OF THE INVENTION

The heat transfer recording material of the invention can constitute a multi-color image-receiving material as mentioned above. A multi-color image-receiving material can be formed by at least two heat transfer recording materials having different color image-forming layers and an image-receiving material. The number of heat transfer recording materials having different color image-forming layers is preferably 3 or more, more preferably 4 or more, even more preferably 5 or more. The colors of the image-forming layers, if they are three, are preferably process colors, i.e., yellow (Y), magenta (M) and cyan (C). The colors of the image-forming layers, if they are four, are preferably yellow (Y), magenta (M), cyan (C) and white (W) or black (K). The colors of the image-forming layers, if they are five, are preferably black (K) or white (W) in addition to the aforementioned four colors.

The heat transfer recording material may further comprise image-forming layers of colors which cannot be expressed by the combination of process colors, e.g., green (G), orange (O), red (R), blue (B), gold (Go), silver (S) and pink (P).

In the invention, at least one of these color heat transfer recording materials is preferably a white heat transfer recording material (hereinafter occasionally referred to as “heat transfer recording material W”).

In an embodiment of the invention, the white heat transfer recording material comprises a light-to-heat conversion material and a matting agent having a predetermined particle diameter incorporated in a light-to-heat conversion layer and titanium oxide (as a white pigment) incorporated in an image-forming layer. The light-to-heat conversion layer is preferably formed from a polyamideimide resin. As the light-to-heat conversion material, there is preferably used an infrared-absorbing dye having a specific structure.

As the white pigment to be incorporated in the image-forming layer, there is preferably used particulate titanium oxide having a particle diameter of from 0.2 μm to 0.4 μm, the surface of which is coated with an alumina or a silica.

In an embodiment of the heat transfer recording material of the invention, the ratio A/X of the absorbance A of the light-to-heat conversion layer at a specific wavelength to the thickness X (μm) of the light-to-heat conversion layer is controlled to be from 2.5 to 3.2, preferably from 2.8 to 3.1, and the absorbance A of the light-to-heat conversion layer at the specific wavelength is controlled to be from 1.0 to 2.0, preferably from 1.3 to 1.75.

The term “absorbanceA” as used herein is meant to indicate the absorbance of the light-to-heat conversion layer at the specific wavelength which can be measured by any known spectrophotometer. In the invention, a Type UV-240 ultraviolet spectrophotometer (produced by Shimadzu Corporation) was used. The absorbance A is calculated by subtracting the absorbance of the support alone from that of the material comprising the light-to-heat conversion layer and the support.

The specific wavelength is preferably the peak wavelength of laser light, if used in heat transfer recording. The peak wavelength is preferably 780 nm, 808 nm and 830 nm, more preferably 808 nm.

In the light-to-heat conversion layer of the heat transfer recording material, the ratio A/X of the absorbance A of the light-to-heat conversion layer at 808 nm to the thickness X (μm) of the light-to-heat conversion layer is controlled to be from 2.5 to 3.2, preferably from 2.7 to 3.0, and the absorbance A of the light-to-heat conversion layer at 808 nm is controlled to be from 1.0 to 2.0, particularly from 1.3 to 1.7.

By predetermining the ratio (A/X) of the absorbance A of the light-to-heat conversion layer to the thickness X (μm) of the light-to-heat conversion layer and the absorbance A of the light-to-heat conversion layer within the above defined range, the coloration of the image-forming layer by the decomposition products of the light-to-heat conversion dye can be minimized, the sensitivity during recording can be enhanced and the image quality can be improved.

Further, by predetermining A/X within the above defined range, transferred images can be formed in a size as large as 515 mm or more ×728 mm or more at a resolution of preferably 2,400 dpi or more, more preferably 2,600 dpi or more.

In the heat transfer recording material of the present embodiment, too, the light-to-heat conversion layer preferably contains an infrared-absorbing dye, particularly one represented by the aforementioned formula (1) as a light-to-heat conversion material. In this case, the color of the image-forming layer of the heat transfer recording material is preferably white (W) developed by titanium oxide as a main component of white pigment.

The process for the formation of a multi-color image using a multi-color image-receiving material for a heat transfer recording using laser, the multi-color image-receiving material comprising a heat transfer recording material of the invention, comprises a step of superposing the heat transfer recording material on the image-receiving material in such an arrangement that the image-forming layer and the image-forming layer are opposed to each other, irradiating the heat transfer recording material with laser light and then transferring the laser-irradiated area of the image-forming layer onto the image-receiving layer of the image-receiving material to record an image.

The order of use of the heat transfer recording materials at the image-forming step is not specifically limited. However, in the case where a multi-color image is formed on a final receiving transparent material using a W heat transfer recording material, the W heat transfer recording material may be used finally so that images of colors other than W are sequentially superposed on the image-receiving layer and a W solid image is then formed on the uppermost layer, making it possible to retransfer a multi-color image onto the final receiving transparent material together with the image-receiving layer, in which the uppermost layer is superposed on the final receiving transparernt material, and hence provide a sharp multi-color image to advantage.

Since the heat transfer image thus formed is formed by dots having a sharp shape, fine lines constituting fine letters can be sharply reproduced. The heat generated by laser light can be delivered up to the transferring interface without being diffused crosswise, causing the image-forming layer to be sharply broken on the interface of heated area with unheated area. Thus, the reduction of the thickness of the light-to-heat conversion layer in the heat transfer recording material and the dynamic properties of the image-forming layer can be controlled.

Simulation shows that the temperature of the light-to-heat conversion layer instantaneously reaches about 700° C. Thus, the light-to-heat conversion layer is subject to deformation or destruction when it is thin. When the light-to-heat conversion layer undergoes deformation or destruction, actual troubles can occur such as transfer of the light-to-heat conversion layer with the transferring layer to the transfer material and ununiformity in transfer image. On the other hand, in order to obtain a predetermined temperature, a light-to-heat conversion material must be present in the light-to-heat conversion layer in a high concentration, causing problems such as precipitation of dye and movement of dye to the adjacent layers.

Therefore, it preferred that an infrared-absorbing dye excellent in light-to-heat conversion properties or heat-resistant binder such as polyimide-based resin be selected so that the thickness of the light-to-heat conversion layer is reduced to about 1.0 μm or less, preferably about 0.5 μm or less.

In general, when the light-to-heat conversion layer undergoes deformation or the image-forming layer itself undergoes deformation at high temperature, the image-forming layer which has been transferred onto the image-receiving layer shows unevenness in thickness corresponding to the subsidiary scanning pattern of laser light, giving an image having an ununiformity that reduces the apparent transfer density. This tendency becomes more remarkable as the thickness of the image-forming layer decreases. On the contrary, when the image-forming layer has a great thickness, the sharpness of dots are lost and the sensitivity is reduced.

In order to meet the two conflicting requirements at the same time, it is preferred that a low melting material such as wax be incorporated in the image-forming layer to eliminate unevenness in transferring. Alternatively, an inorganic particulate material may be added instead of binder to properly reduce the thickness of the image-forming layer, causing the image-forming layer to be broken at the interface of heated area with unheated area and hence making it possible to eliminate unevenness in transferring while maintaining desired dot sharpness and sensitivity.

In general, when the heat transfer recording material-coating layer absorbs moisture, it shows a change of dynamic physical properties and thermal physical properties, giving a humidity dependence of recording atmosphere.

In order to eliminate the dependence on temperature and humidity, the dye/binder to be used in the light-to-heat conversion layer and the binder to be used in the image-forming layer are preferably an organic solvent-based material.

In order to prevent the infrared-absorbing dye from changing in its hue due to heat during printing when moved from the light-to-heat conversion layer to the image-forming layer, the light-to-heat conversion layer is preferably designed by the combination of an infrared-absorbing dye having a strong retaining power and a binder as previously mentioned.

The image-receiving material and the heat transfer recording material are preferably retained on a drum by vacuum suction. Vacuum suction is important because the bonding strength of the two materials is controlled to form an image and the behavior of image transferring is very sensitive to the clearance between the image-receiving surface of the image-receiving material and the image-forming surface of the transfer material. When the presence of foreign matters such as dust triggers to expand the clearance between the two materials, image defects or unevenness in image transferring can occur.

In order to prevent the occurrence of such image defects or unevenness in image transferring, it is preferred that the heat transfer recording material or the image-receiving material be uniformly roughened to allow smooth passage of air and obtain a uniform clearance.

Ordinary examples of the method for roughening the heat transfer recording material or the image-receiving material include post-treatment such as embossing and incorporation of a matting agent in the coating layer. For the simplification of the production step and the stabilization of the age stability of the material, the incorporation of a matting agent, particularly in the light-to-heat conversion layer, is preferred.

In order to make it assured that the sharp dots can be reproduced as previously mentioned, the recording device, too, must be designed with a high precision. In some detail, those disclosed in JP-A-2002-337468, paragraph (0027), may be used, but the invention is not limited thereto.

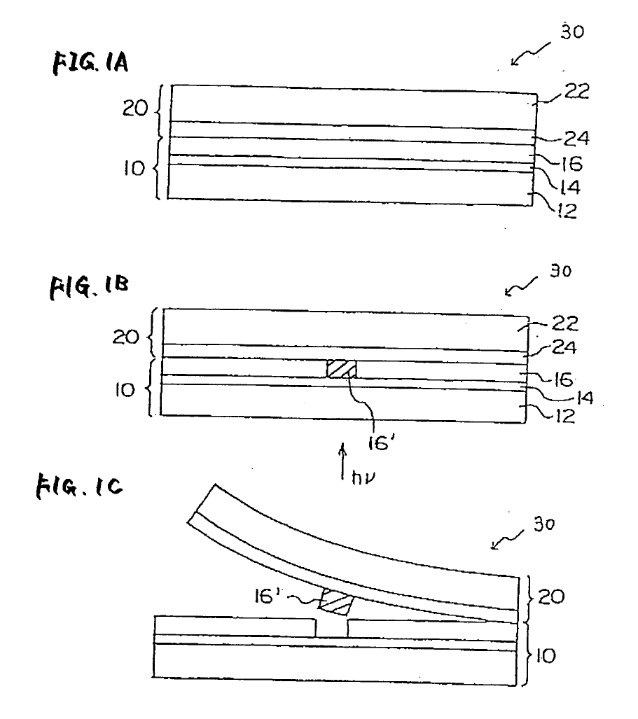

The outline of a mechanism of formation of a multi-color image by thin film heat transfer using laser light will be described hereinafter in connection with FIGS. 1A-1C.

An image-forming layered product 30 comprising an image-receiving material 20 superposed on the surface of an image-forming layer 16 of a heat transfer recording material 10 is prepared. The heat transfer recording material 10 comprises a support 12, a light-to-heat conversion layer 14 provided on the support 12 and an image-forming layer 16 provided on the light-to-heat conversion layer 14. The image-receiving material 20 comprises a support 22 and an image-receiving layer 24 provided on the support 22. The image-receiving material 20 is superposed on the heat transfer recording material 10 in such an arrangement that the image-receiving layer 24 comes in contact with the surface of the image-forming layer 16 (see FIG. 1A). When the layered product 30 is imagewise irradiated with a laser light on the support 12 of the heat transfer recording material 10 in time sequence, the laser light-irradiated area of the light-to-heat conversion layer 14 of the heat transfer recording material 10 generates a heat, causing the drop of the adhesion to the image-forming layer 16 (see FIG. 1B) Thereafter, when the image-receiving material 20 and the heat transfer recording material 10 are peeled off each other, the laser light-irradiated area 16′ of the image-forming layer 16 is then transferred onto the image-receiving layer 24 of the image-receiving material 20 (see FIG. 1C).

The laser head for emitting the laser light is preferably a multi-beam laser capable of emitting two or more laser lights at the same time.

The kind, intensity, beam diameter, power, scanning speed, etc. of the laser head for emitting laser light will be described in detail below, but the invention is not limited thereto.

Examples of laser light employable herein include gas laser light such as argon ion laser light, helium neon laser light and helium cadmium laser light; solid laser light such as YAG laser light; and direct laser light such as semiconductor laser light, dye laser light and excima laser light. Alternatively, light obtained by passing such laser light through a second harmonic element so that the wavelength thereof is halved maybe used. In a multi-color image formation process, semiconductor laser light is preferably used taking into account ease of control of output power and modulation. In a multi-color image formation process, the laser light is preferably emitted in such a manner that the diameter of beam on the light-to-heat conversion layer is from 5 μm to 50 μm (particularly from 6 μm to 30 μm). Further, the scanning speed is preferably predetermined to be 1 m/sec or more (particularly 3 m/sec or more).

Referring to the process for the formation of a multi-color image, a plurality of heat transfer recording materials may be used as previously mentioned. A large number of image layers (image-forming layers having an image formed thereon) are repeatedly superposed on one image-receiving material to form a multi-color image. Alternatively, an image may be formed on a plurality of image-receiving layers from which the image is then retransferred onto a final receiving material to form a multi-color image.

Referring to heat transfer recording by irradiation with laser light emission, the morphological change of the pigment, dye and image-forming layer during transfer is not specifically limited so far as the laser light can be converted to heat that can be used to transfer the image-forming layer comprising a pigment onto the image-forming layer to form an image thereon. In some detail, the pigment, dye and image-forming layer may be in any form such as solid, softened state, liquid state and gaseous state, preferably solid or softened state. Examples of the heat transferring process by irradiation with laser light include melt transferring, transferring by ablation and sublimation transferring, which have been heretofore known.

Preferred among these heat transferring processes are thin film transferring as previously mentioned, melt transferring and ablation transferring because they can form an image having a hue similar to printed quality.

In order to effect the step of transferring the image-receiving material having an image printed thereon by the recording device onto the final receiving material (e.g., final printing paper (referred to as “final paper”), a heat transferring device is normally used. When the image-receiving material and the final receiving material are heated under pressure in superposed form, the two materials are bonded. Thereafter, when the image-receiving material is peeled off the transfer material, only the image-receiving layer containing an image is left behind on the final receiving material.

The image formed on the image-receiving layer or the final receiving material may be subjected to post-exposure to light having an intensity in the ultraviolet range. The coloration by the infrared-absorbing dye or its decomposition products in the image-forming layer can be quenched by a photoradical generator. When post-exposure is made, the subsequent change of hue by indoor exposure can be prevented.

As the light source for post-exposure there is preferably used a light source emitting light having a wavelength that can be absorbed by the photoradical generator, such as fluorescent tube, black light and metal halide lamp.

The aforementioned units can be connected to the plate-making system to form a system capable of performing as a color proof. This system is required to allow the aforementioned recording device to output printed matters having an image quality as close as possible to that of printed matters outputted from the plate-making data. To this end, a software for approximating the color and halftone of the output to that of printed matters is needed. Specific examples of the system connection employable herein include those disclosed in JP-A-2002-337468, paragraph (0040). However, the invention is not limited to these examples.

The heat transfer recording material and image-receiving material suitable for the recording device in the aforementioned system will be described hereinafter.

(Heat Transfer Recording Material)

The heat transfer recording material comprises a light-to-heat conversion layer, an image-forming layer and optionally other layers provided on a support.

(Support)

The material of the support for the heat transfer recording material is not specifically limited. Various support materials maybe used depending on the purpose. In some detail, those disclosed in JP-A-2002-337468, paragraph (0051) may be used, but the invention is not limited thereto.

The support for the heat transfer recording material may be subjected to surface activation and/or coating with one or more undercoating layers to enhance the adhesion to the light-to-heat conversion layer which is to be provided thereon. Examples of surface activation employable herein include glow discharge treatment, and corona discharge treatment. As the material of the undercoating layer there is preferably used one having a high adhesion to the surface of both the support and the light-to-heat conversion layer, a small thermal conductivity and an excellent heat resistance. Examples of the material of the undercoating layer employable herein include styrene, styrene-butadiene copolymer, and gelatin. The thickness of the entire undercoating layer is normally from 0.01 to 2 μm. The heat transfer recording material may be optionally subjected to provision of various functional layers such as antireflection layer and antistatic layer or surface treatment on the side thereof opposite the side on which the light-to-heat conversion layer is provided. In some detail, a back layer disclosed in JP-A-2002-337468, paragraph (0053) may be used, but the invention is not limited thereto.

(Light-to-Heat Conversion Layer)

The light-to-heat conversion layer comprises a light-to-heat conversion material, a binder and optionally other components incorporated therein. In an embodiment of implementation of the invention, the light-to-heat conversion layer further comprises a matting agent incorporated therein.

The light-to-heat conversion material is capable of converting the optical energy emitted to heat energy. In formula, a dye capable of absorbing laser light (hereinafter including pigment) is used. In the case where infrared laser light is used to perform image recording, as the light-to-heat conversion material there is preferably used an infrared-absorbing dye. Examples of the infrared-absorbing dye employable herein include black pigments such as carbon black, macrocyclic compound pigments having absorption in the range of from visible light to near infrared such as phthalocyanine and naphthalocyanine, organic dyes used as laser-absorbing material for high density laser recording unit such as optical disc (e.g., cyanine dye such as indolenine dye, anthraquinone-based dye, azlene-based dye, phthalocyanine-based dye), and organic metal compound dyes such as dithiol-nickel complex. Among these infrared-absorbing dyes, the cyanine dye exhibits a high absorptivity coefficient with respect to light in the infrared range and thus can be used as a light-to-heat conversion material to form a thinner light-to-heat conversion layer, making it possible to further enhance the recording sensitivity of the heat transfer recording material.

As the light-to-heat conversion material there may be used an inorganic material such as particulate metal material (e.g., blackened silver) besides dye.

As the light-to-heat conversion material to be used in the invention, a compound represented by the aforementioned formula (1) is extremely preferred because it has an excellent heat resistance and thus undergoes no decomposition and hence no absorbance drop even after aged in the form of coating solution. It is particularly preferred that the compound of formula (1) be used in combination with a polyamideimide resin (binder).

In formula (1), examples of the ring formed by Z include a benzene ring, a naphthalene ring, and heterocyclic aromatic rings such as pyridine ring, quinoline ring, pyrazine ring and quinoxaline ring. Z may further have other substituents R⁶ connected thereto. Examples of the substituents R⁶ include various substituents such as alkyl group, aryl group, heterocyclic residue, halogen atom, alkoxy group, aryloxy group, alkylthio group, arylthio group, alkylcarbonyl group, arylcarbonyl group, alkyloxycarbonyl group, aryloxycarbonyl group, alkylcarbonyloxy group, arylcarbonyloxy group, alkylamide group, arylamide group, alkylcarbamoyl group, arylcarbamoyl group, alkylamino group, arylamino group, carboxyl group, alkylsulfonyl group, arylsulfonyl group, alkylsulfonamide group, arylsulfonamide group, alkylsulfmaoyl group, arylsulfamoyl group, cyano group and nitro group. The number (p) of the aforementioned substituents to be connected to Z is generally preferably 0 or from about 1 to 4. When p is 2 or more, the plurality of R⁶'s may be the same or different.

Preferred among the substituents represented by R⁶ are halogen atom (e.g., F, Cl), cyano group, substituted or unsubstituted C₁-C₂₀ alkoxy group (e.g., methoxy group, ethoxy group, dodecyloxy group, methoxyethoxy group), C₆-C₂₀ substituted or unsubstituted phenoxy group (e.g., phenoxygroup, 3,5-dichlorophenoxy group, 2,4-di-t-pentylphenoxy group), substituted or unsubstituted C₁-C₂₀ alkyl group (e.g., methyl group, ethyl group, isobutyl group, t-pentyl group, octadecyl group, cyclohexyl group), and C₆C₂₀ phenyl group (e.g. , phenyl group, 4-methylphenyl group, 4-trifluoromethylphenyl group, 3,5-dichlorophenyl group).

In formula (1), T represents —O—, —S—, —Se—, —N(R¹)—, —C(R²)(R³)— or —C(R⁴)═C(R⁵)—. In this case, the groups represented by R¹, R², R³, R⁴ and R⁵ are preferably substituted or unsubstituted alkyl group, aryl group and alkenyl group, particularly alkyl group. Examples of the groups represented by R⁴ and R⁵ include hydrogen atom, halogen atom, alkyl group, aryl group, alkoxy group, aryloxy group, carboxyl group, acyl group, acylamino group, carbamoyl group, sulfamoyl group or sulfonamide group which may further have substituents. The number of carbon atoms in the groups represented by R¹ to R⁵ is preferably from 1 to 30, particularly from 1 to 20.

In the case where the groups represented by R¹ to R⁵ further have substituents, examples of these substituents include sulfonic group, alkylcarbonyloxy group, alkylamide group, alkylsulonamide group, alkoxycarbonyl group, alkylamino group, alkylcarbamoyl group, alkylsulfamoyl group, alkoxy group, aryloxy group, alkylthio group, arylthio group, alkyl group, aryl group, carboxyl group, halogen atom, and cyano group.

Particularly preferred among these substituents are halogen atom (e.g., F, Cl), cyano group, substituted or unsubstituted C₁-C₂₀ alkoxy group (e.g., methoxy group, ethoxy group, dodecyloxy group, methoxyethoxy group), C₆-C₂₀ substituted or unsubstituted phenoxy group (e.g., phenoxy group, 3,5-dichlorophenoxy group, 2,4-di-t-pentylphenoxy group), substituted or unsubstituted C₁-C₂₀ alkyl group (e.g., methyl group, ethyl group, isobutyl group, t-pentyl group, octadecyl group, cyclohexyl group), and C₆-C₂₀phenyl group (e.g., phenyl group, 4-methylphenyl group, 4-trifluoromethylphenyl group, 3,5-dichlorophenyl group). Most desirable among the groups represented by R¹ to R⁵ is C₁-C₆ unsubstituted alkyl group. T is particularly preferably —C(CH₃)₂—.

In formula (1), L represents atrivalent connecting group produced by the connection of 5 or 7 methine groups with a conjugated double bond and may be substituted. In some detail, L represents a pentamethine or heptamethine group produced by the connection of methine groups with a conjugated double bond. Specific preferred examples of the pentamethine or heptamethine group include those represented by the following formulae (L-1) to (L-6).

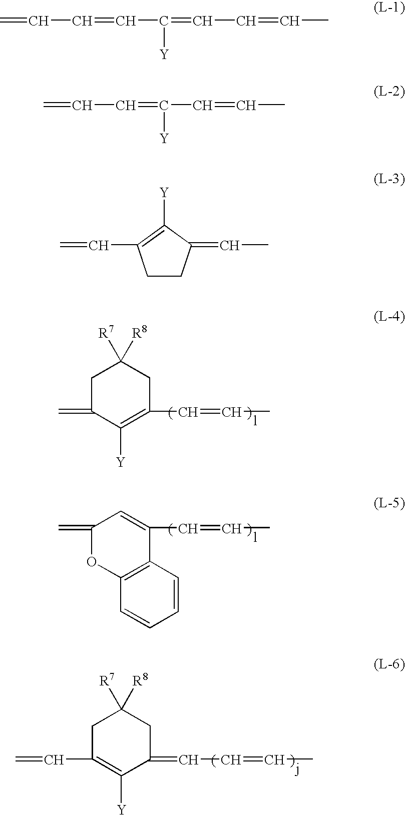

Particularly preferred among these specific examples are connecting groups forming tricarbocyanine exemplified by (L-2), (L-3), (L-4), (L-5) and (L-6). In the aforementioned formulae (L-1) to (L-6), Y represents a hydrogen atom or monovalent group. Preferred examples of the monovalent group represented by Y include lower alkyl groups (e.g., methyl group), lower alkoxy groups (e.g., methoxy group), substituted amino groups (e.g., dimethylamino group, diphenylamino group, methylphenylamino group, morpholino group, imidazolidine group, ethoxycarbonylpiperadine group), alkylcarbonyloxy groups (e.g., acetoxygroup), alkylthio group (e.g., methylthio group), cyano groups, nitro groups, and halogen atom (e.g., Br, Cl, F). Preferred examples of the groups represented by R⁷ and R⁸ include hydrogen atom and alkyl group.

Particularly preferred among the groups represented by Y is hydrogen atom. Particularly preferred among the groups represented by R⁷ and R⁸ are hydrogen atom and lower alkyl group (e.g., methylgroup), respectively. Informulae (L-4) to (L-6), i represents an integer of 1 or 2 and j represents an integer of 0 or 1.

In formula (1) M represents a divalent connecting group, preferably substituted or unsubstituted C₁-C₂₀ alkylene group. Examples of such an alkylene group include ethylene group, propylene group, and butylene group.

In formula (1), examples of the cation represented by X⁺ include metallic ions (Na⁺, K⁺), ammonium ions (e.g., ion represented by HN⁺(C₂H₅)₃), and pyridinium ion.

Specific examples of the compound represented by formula (1) include those exemplified below, but the invention is not limited thereto. Particularly preferred among the following specific examples is compound (I-17) represented by the aforementioned formula (2).

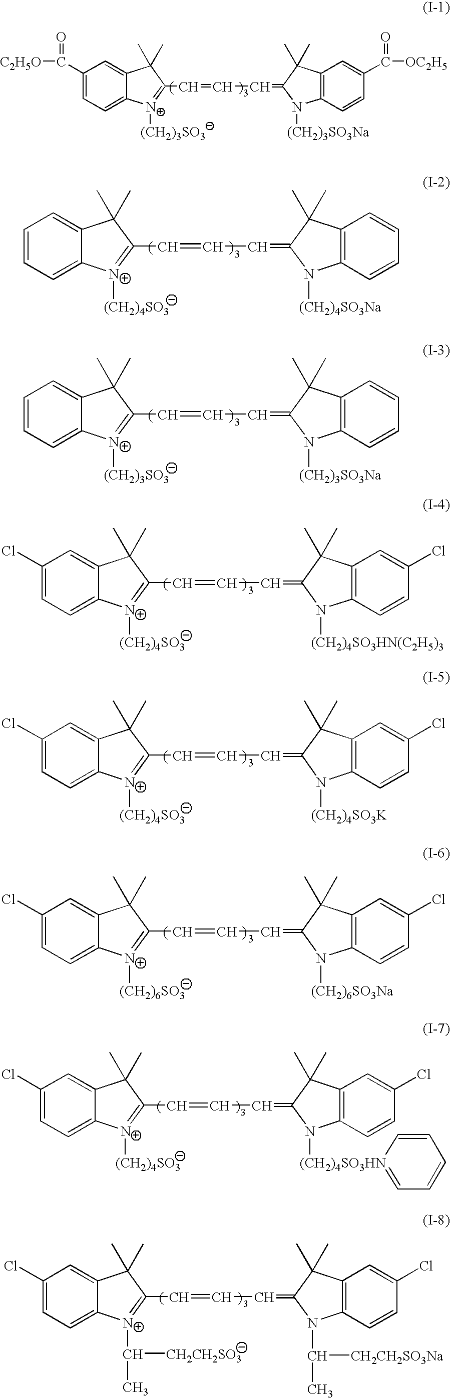

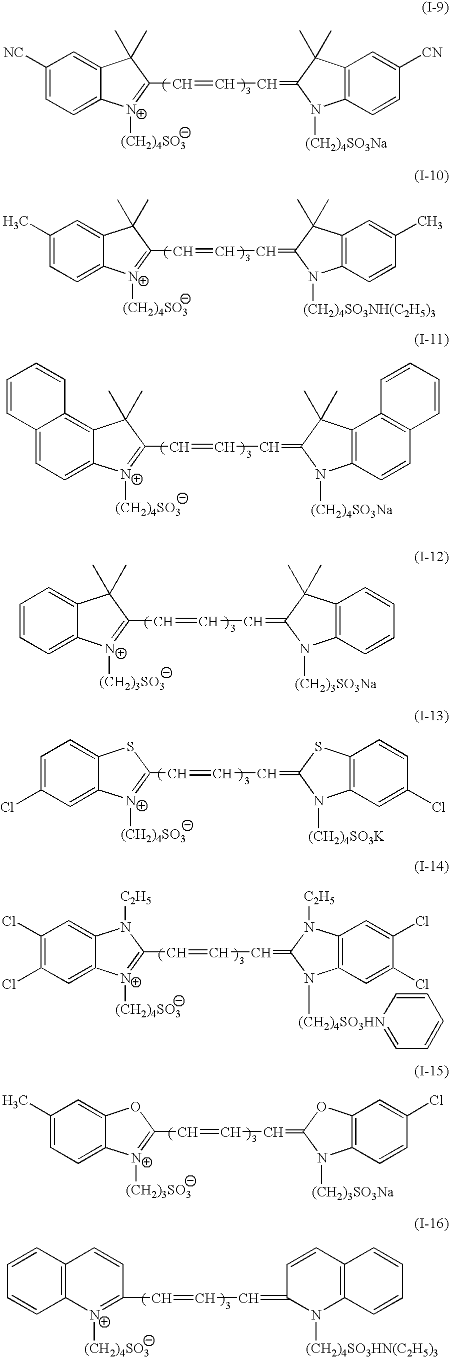

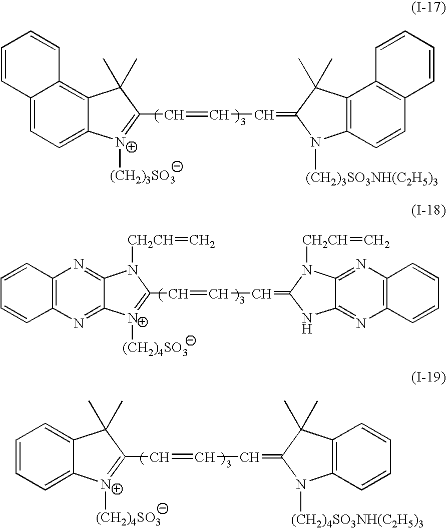

The compound represented by the aforementioned formula (1) can normally be easily synthesized as in the synthesis of carbocyanine dye. In some detail, the compound represented by formula (1) can be easily synthesized by reacting a heterocyclic enamine with an acetal such as CH₃O—CH═CH—CH═CH—CH(OCH₃)₂ or compound represented by PHN—CH—(CH—CH)—NHPh in which Ph represents a phenyl group. For the details of method for synthesis of these compounds, reference can be made also to JP-A-5-116450.

When the light-to-heat conversion material has a high decomposition temperature and thus can be difficultly decomposed, fogging due to coloration by the decomposition products thereof can be prevented. From this standpoint of view, the decomposition temperature of the light-to-heat conversion layer is preferably 200° C. or more, more preferably 250° C. or more. When the decomposition temperature of the light-to-heat conversion material is lower than 200° C., the resulting decomposition of the light-to-heat conversion material gives decomposition products that cause coloration leading to fogging and hence image quality deterioration.

The light-to-heat conversion layer preferably comprises the light-to-heat conversion material (preferably, infrared-absorbing dye) in an amount of no less than 5 wt % and no more than 20 wt %, more preferably no less than 12 wt % and no more than 17 wt %, based on the total content of the light-to-heat conversion layer.

The binder to be incorporated in the light-to-heat conversion layer is preferably a polyimide resin or polyamideimide resin.

The polyamideimide resin to be used herein is not specifically limited so far as it can be dissolved in a solvent and acts as a binder but is preferably a resin which at least has a strength such that a layer can be formed on a support and a high thermal conductance.

The polyamideimide to be used as a binder preferably has a heat decomposition temperature (temperature at which the weight loss is 5% as determined by TGA method (thermogravimetric analysis) at a temperature rising rate of 10° C./min in an air stream) of 400° C. or more, more preferably 500° C. or more. The polyamideimide preferably has a glass transition temperature of from 200° C. to 400° C., more preferably from 250° C. to 350° C. When the glass transition temp of the polyamideimide is lower than 200° C., the resulting image can undergo fogging. On the contrary, when the glass transition temp of the polyamideimide is higher than 400° C., the resulting resin has a lowered solubility that can reduce the producibility.

It is preferred that the heat resistance (e.g., heat deformation temperature, heat decomposition temperature) of the binder in the light-to-heat conversion layer be higher than that of the material used in other layers provided on the light-to-heat conversion layer.

The polyamideimide which is preferably used in the invention is one represented by the following formula (3):

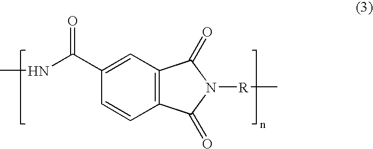

In formula (3), R represents a divalent connecting group. Specific preferred examples of the divalent connecting group will be given below.

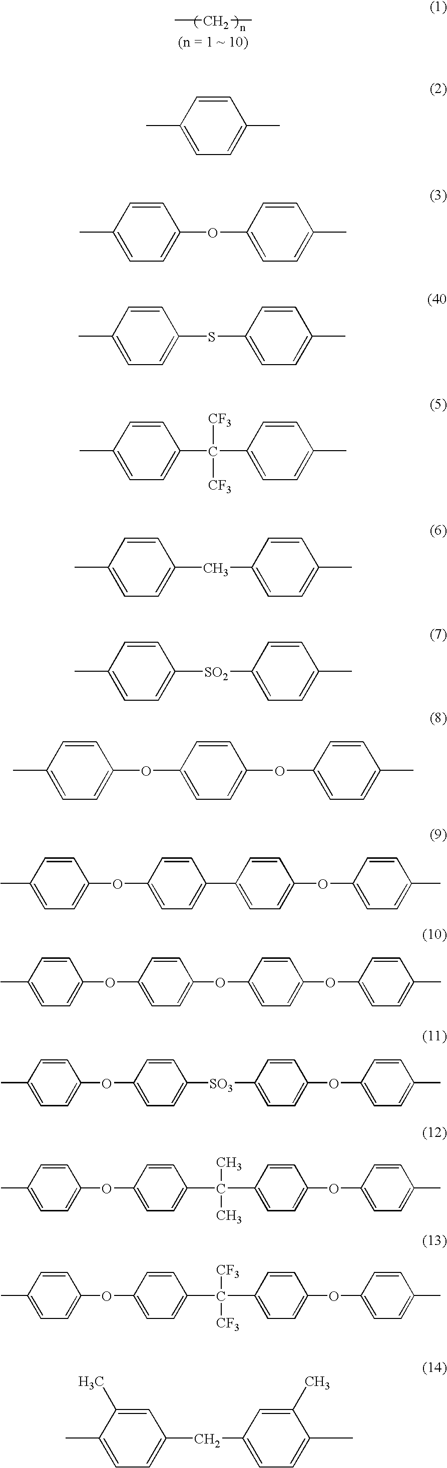

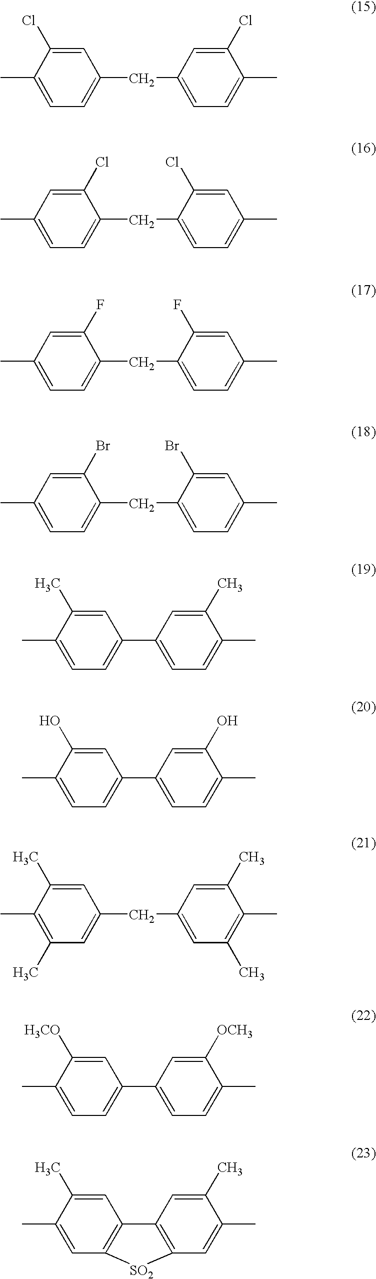

Preferred among these connecting groups are (6), (7), (11) and (14).

These divalent connecting groups may be used singly. Alternatively, a plurality of these divalent connecting groups may be connected.

The number-average molecular weight of the polyamideimide represented by formula (1) is preferably from 3,000 to 50,000, more preferably from 10,000 to 25,000 as calculated in terms of polystyrene measured by gel permeation chromatography.

As the binder in the light-to-heat conversion layer there may be used a polyamideimide resin in combination with other resins. Examples of the other resins to be used include those disclosed in JP-A-2002-337468, paragraph (0062). A polyimide resin is preferably used. The proportion of the other resins to be used in combination with the polyamideimide resin is preferably from 5% to 50%, more preferably from 10t to 30%.

As the particulate matting agent to be incorporated in the light-to-heat conversion layer there is preferably used one disclosed in JP-A-2002-337468, paragraph (0074), particularly particulate silica and particulate silicone resin. The particle diameter of the particulate matting agent is normally from 0.5 μm to 30 μm, preferably from 0.5 μm to 20 μm.

The particulate silicone resin has a smaller specific gravity and hence provides a higher liquid stability than the particulate silica and thus is more desirable than the particulate silica. However, the particulate silicone resin has a greater particle diameter distribution and contains giant particles formed by aggregation of a plurality of matting agent particles more often than the particulate silica. Such an aggregate, if any, causes no image recording and thus can cause the occurrence of white marks. It is therefore preferred that a matting agent which has been subjected to classification to remove such an aggregate be used. As the method for classifying the matting agent particles there maybe properly used any method so far as the particles can be properly classified. Examples of the classification method employable herein include classification by sieve, classification by dry process air classifier, and classification by wet process air classifier. Among these classification methods, as the classification by wet process air-classifier, the classification by dry process air classifier requires no waste water disposal and is simple. Further, the classification by dry process air classifier has a higher precision and efficiency than classification by sieve. Thus, the classification by dry process air classifier is preferably used.

In an embodiment of implementation of the invention, the particulate matting agent preferably has an average particle diameter of more than 0.5 μm and less than 5 μm and contains particles or aggregates having a major axis length of 15 μm or more in a proportion of 100 ppm by volume or less. More preferably the particulate matting agent has an average particle diameter of from 1.1 μm to 3 μm and contains particles or aggregates having a major axis length of 15 μm or more in a proportion of 20 ppm by volume or less. The average particle diameter of the particulate matting agent can be determined by photographing the particles under scanning electron microscope. The amount of the matting agent to be added is preferably from 0.1 to 100 mg/m².

By incorporating at least one of vinyl pyrrolidone homopolymer and copolymer in the light-to-heat conversion layer, the sensitivity of the heat transfer recording material and the edge sharpness of the printed image can be enhanced.

The copolymer component which acts as vinyl pyrrolidone copolymer is not specifically limited so far as it is not compatible with the polyimide resin or polyamide resin but is preferably vinyl acetate, styrene, olefin, acrylic acid or methacrylic acid, particularly styrene. One or more of these components can be copolymer components of the vinyl pyrrolidone copolymer. The molar ratio of vinyl pyrrolidone component to its copolymer components in the vinyl pyrrolidone copolymer (vinyl pyrrolidone:copolymer components) is preferably 50 to less than 100:more than 0 to 50 or less, more preferably 60 to 90:10 to 40.

The weight-average molecular weight of the vinyl pyrrolidone polymer or vinyl pytrolidone copolymer is preferably from 2,000 to 500,000, more preferably from 10,000 to 250,000.

Preferred examples of the vinyl pyrrolidone copolymer include vinyl pyrrolidone/vinyl acetate copolymer, vinyl pyrrolidone/styrene copolymer, vinyl pyrrolidone/1-butene copolymer, and vinyl pyrrolidone/acrylic acid copolymer.

While a vinyl pyrrolidone polymer and/or vinyl pyrrolidone copolymer is incorporated in the light-to-heat conversion layer in the invention, the form of incorporation is not specifically limited and arbitrary. In the light-to-heat conversion layer, the mixing ratio of the vinyl pyrrolidone polymer and/or vinyl pyrrolidone copolymer to the main binder is preferably from 0.1 to 30% by weight, more preferably from 1 to 10% by weight.

The light-to-heat conversion layer may further comprise a surface active agent, a thickening agent, an antistatic agent, etc. incorporated therein as necessary.

The light-to-heat conversion layer can be provided by dissolving a light-to-heat conversion material and a binder in a solvent, optionally adding a matting agent and other components to the solution to prepare a coating solution, spreading the coating solution over a support, and then drying the coat layer.

The thickness of the light-to-heat conversion layer is preferably from 0.03 μm to 1.0 μm, more preferably from 0.2 μm to 0.7 μm. The light-to-heat conversion layer preferably has an optical density of from 1.0 to 2.0, more preferably from 1.3 to 1.8 with respect to light beam having a wavelength of 808 nm to enhance the transferring sensitivity of the image-forming layer.

The ratio of absorbance to thickness (μpm) is preferably from 2.5 to 3.2, more preferably from 2.7 to 3.1. When this ratio is less than 2.5, the resulting transferring speed is reduced. On the contrary, when this ratio is more than 3.2, the resulting transferred image is more subject to yellowing.

(Image-Forming Layer)

The image-forming layer contains at least a pigment which is transferred onto the image-receiving material to form an image. The image-forming layer further contains a binder for forming the layer, a photoradical generator and optionally other components. Pigments can be roughly divided into two groups, i.e., organic pigment and inorganic pigment. The former is excellent in transparency of coat layer in particular. The latter is normally excellent in hiding power, etc. Therefore, these pigments may be properly selected depending on the purpose. In the case where the aforementioned heat transfer recording material is used for color proof of printed matters, organic pigments having a tone identical or close to that of yellow, magenta, cyan and black normally used in printing ink are preferably used. In some detail, those disclosed in JP-A-2002-337468, paragraph (0080) may be used, but the invention is not limited thereto. In the art of package, inorganic pigments corresponding to white ink may be used. In addition, metallic powders and fluorescent pigments for metallic tone may be used.

The average particle diameter of the aforementioned pigments is preferably from 0.03 μm to 1 μm, more preferably from 0.05 μm to 0.5 μm.

The particle diameter of titanium oxide as white pigment for white heat transfer recording material is preferably from 0.2 μm to 0.4 μm, more preferably from 0.2 μm to 0.35 μm, particularly from 0.27 μm to 0.32 μm.

A particulate titanium oxide is normally subjected to surface treatment for the purpose of enhancing its dispersibility and weathering resistance. Referring further to weathering resistance, surface treatment is effected for the purpose of coating the surface of titanium oxide to suppress the photocatalytic activity thereof because titanium oxide is so photocatalytic that it attacks the coat layer when it absorbs ultraviolet rays. The kind of surface treatment to be effected may be selected from the following examples depending on the purpose. The spread will be described later. Examples of inorganic treatment include alumina treatment, silica-alumina treatment, titania treatment, and zirconia treatment. Examples of organic treatment include polyvalent alcohol treatment, amine treatment, silicone treatment, and aliphatic acid treatment. Silica-alumina treatment is advantageous in that a high hiding power can be obtained.

In the invention, the image-forming layer preferably comprises particulate titanium oxide coated with alumina and silica (hereinafter occasionally referred to as “titanium oxide according to the invention”) incorporated therein.

The particle diameter of the titanium oxide according to the invention is obtained by measuring the particle diameter of the particles thus coated. The weight-average particle diameter is calculated from measurements by TEM.

The spread of alumina and silica over titanium oxide is the proportion of alumina and silica to titanium oxide. In order to obtain a high coverage, it is necessary that the spread of alumina and silica be 5% by weight or more, preferably from 6 to 9% by weight. The titanium oxide is preferably of rutile type, which provides a high coverage.

Since the titanium oxide according to the invention provides has a high coverage, the ratio of the reflection optical density (reflection OD) as measured on the solid image area of recorded image on the image-forming layer of white heat transfer recording material through a visual filter to the thickness (μ) of the image-forming layer (reflection OD/thickness) can be predetermined to be 0.15 or more, more preferably 1.60 or more. The reflection OD is obtained by measuring solid image recorded on a transparent transfer material on a black backing using X-rite 938 for example. The reflection OD is preferably 0.6 or less, more preferably 0.4 or less. The less the reflection OD is, the higher is whiteness, i.e., the higher is the hiding power, that is, the more difficultly can be seen undesirable colors through the image formed on the transfer material and the more sharply can be seen only the image formed by heat transfer. However, the reflection OD is preferably not lower than about 0.35.

Accordingly, the thickness of the image-forming layer of white heat transfer recording material of the invention is preferably 2.0 μm or less, more preferably 1.8 μm or less, even more preferably 1.5 μm or less. In accordance with the invention, the thickness of the image-forming layer can be relatively reduced, making it possible to obtain desired hiding power and recording sensitivity at the same time.

Referring to the white pigment to be incorporated in the image-forming layer of white heat transfer recording material, the titanium oxide according to the invention may be used in combination with calcium carbonate, calcium sulfate, etc. so far as the effect of the invention can be maintained.

As the binder to be used in the image-forming layer there maybe used one disclosed in JP-A-2002-337468, paragraph (0085), but the invention is not limited thereto.

The aforementioned image-forming layer may comprise the following components (1) to (4) incorporated therein as the aforementioned other components.

(1) Waxes

As waxes there may be used those disclosed in JP-A-2002-337468, paragraph (0087), but the invention is not limited thereto.

(2) Plasticizer

As a plasticizer there may be one disclosed in JP-A-2002-337468, paragraph (0090), but the invention is not limited thereto.

(3) Photoradical Generator

As a photoradical generator there may be used any known photoradical generator for use in photopolymerization initiation. Organic compounds having an absorption peak in the range of from 300 to 500 nm, particularly from 300 to 450 nm, even from 300 to 400 nm are advantageous in that they are little subject to coloration. Specific examples of these organic compounds include active halogen compounds, active ester compounds, organic peroxides, lophine dimers, aromatic diazonium salts, aromatic iodonium salts, aromatic sulfonium salts, azinium salts, borates, ketals, aromatic ketones, diketones, thiols, azo compounds, and acylphosphine oxide compounds. Preferred among these organic compounds are acylphosphine oxide compounds such as bis(2,4,6-trimethylbenzoyl)-phenylphosphine oxide and 2,4,6-trimethylbenzoyl diphenylphosphine oxide.

The amount of the photoradical generator to be added is normally from 0.10 to 10 mmol/m², preferably from 0.1 to 1 mmol/m².

(4) Others

The image-forming layer may further comprise a surface active agent, an inorganic or organic particulate material (e.g., metallic power, silica gel), an oil (e.g., linseed oil, mineral oil), a thickening agent, an antistatic agent, etc. incorporated therein besides the aforementioned components.

The image-forming layer can be provided by dissolving or dispersing a pigment, the aforementioned binder, etc. in a solvent to prepare a coating solution, spreading the coating solution over the light-to-heat conversion layer (over heat-sensitive peeling layer, if provided on the light-to-heat conversion layer), and then drying the coat layer.

On the aforementioned light-to-heat conversion layer of heat transfer recording material can be provided a heat-sensitive peeling layer containing a heat-sensitive material which, when acted upon by the heat generated by the light-to-heat conversion layer, generates a gas or releases adsorbed water or the like to weaken the bonding-strength between the light-to-heat conversion layer and the image-forming layer. As such a heat-sensitive material there may be used a compound which, when acted upon by heat, itself undergoes decomposition or denaturation to generate a gas (polymer or low molecular compound), a compound having a considerable amount of vaporizable liquid such as water (polymer or low molecular compound) or the like. These compounds may be used in combination.

Examples of the polymer which undergoes decomposition or denaturation due to heat to generate a gas include those disclosed in JP-A-2002-337468, paragraph (0097), but the invention is not limited thereto.

In the case where a low molecular compound is used as the heat-sensitive material of the heat-sensitive peeling layer, the low molecular compound is preferably used in combination with a binder. As the binder there may be used a polymer which itself undergoes decomposition or denaturation due to heat to generate a gas. However, ordinary binders having no such properties may be used. The heat-sensitive peeling layer preferably covers the entire surface of the light-to-heat conversion layer. The thickness of the heat-sensitive peeling layer is normally from 0.03 μm to 1 μm. preferably from 0.05 μm to 0.5 μm.

Instead of providing the heat-sensitive peeling layer independently of the light-to-heat conversion layer, the aforementioned heat-sensitive material may be added to the light-to-heat conversion layer coating solution from which a light-to-heat conversion layer that also acts as a heat-sensitive peeling layer can be-formed.

The image-receiving material to be used in combination with the aforementioned heat transfer recording material will be described hereinafter.

(Image-Receiving Material

(Layer Configuration)

The image-receiving material normally comprises a support, one or more image-receiving layers provided thereon and optionally one or more of a cushioning layer, a peeling layer and an interlayer interposed between the support and the image-receiving layer. The image-receiving material may have a back layer provided on the side thereof opposite the image-receiving layer from the standpoint of conveyability.

(Support)

The support to be used in the invention is not specifically limited and may be an ordinary sheet-like substrate made of plastic, metal, glass, resin-coated paper, paper, composite or the like. In some detail, those disclosed in JP-A-2002-337468, paragraph (0102) may be used, but the invention is not limited thereto.

The thickness of the support of the image-receiving material is normally from 10 μm to 400 μm, preferably from 25 μm to 200 μm. The surface of the support may be subjected to surface treatment such as corona discharge and glow discharge to enhance the adhesion to the image-receiving layer (or cushioning layer) or the image-forming layer of the heat transfer recording material.

(Image-Receiving Layer)

One or more image-receiving layers are preferably provided on the support to allow the transfer of the image-forming layer on the surface of the image-receiving material and fix it thereto. As the image-receiving layer there may be used one disclosed in JP-A-2002-337468, paragraph (0106), but the invention is not limited thereto.

(Other Layers)

A cushioning layer may be provided interposed between the support and the image-receiving layer. When such a cushioning layer is provided, the adhesion between the image-forming layer and the image-receiving layer can be enhanced during laser heat transfer to enhance image quality. Further, even when foreign matters are present between the heat transfer recording material and the image-receiving material during recording, the deformation of the cushioning layer causes the reduction of clearance between the image-receiving layer and the image-forming layer, making it possible to reduce the size of image defects such as white mark. In the case where an image transferred is transferred to final printing paper separately prepared, the transferability of the image-receiving layer can be enhanced because the surface of the image-receiving layer can deform according to the roughened surface of paper. Further, by reducing the gloss of the transfer material, the approximation to printed matters can be enhanced.

As the cushioning layer there may be used one disclosed in JP-A-2002-337468, paragraph (0112), but the invention is not limited thereto.

It is necessary that the image-receiving layer and the cushioning layer be bonded to each other until the stage of laser recording. However, it is preferred that the two layers be peelably provided to transfer an image to the final receiving material. In order to facilitate peeling, a peeling layer is preferably provided between the cushioning layer and the image-receiving layer to a thickness of from about 0.1 to 2 μm. The thickness of the peeling layer is needed to be adjusted depending on the kind of the peeling layer because when the thickness of the peeling layer is too great, the properties of the cushioning layer can be difficultly exhibited.

As the peeling layer there may be used one disclosed in JP-A-2002-337468, paragraph (0114), but the invention is not limited thereto.

In the image-receiving material combined with the aforementioned heat transfer recording material, the image-receiving layer may also act as a cushioning layer. In this case, the image-receiving material may comprise a support and a cushioning image-receiving layer or may comprise a support, a undercoating layer and a cushioning image-receiving layer. In this case, too, the cushioning image-receiving layer can be peelably provided so that it can be retransferred to the final transfer material. In this arrangement, the image which has been transferred to the final transfer material is excellent in gloss.

The thickness of the cushioning image-receiving layer is from 5 μm to 100 μm, preferably from 10 μm to 40 μm.

The image-receiving material may have a back layer provided on the side of the support opposite the image-receiving layer to improve the conveyability thereof. The back layer may comprise an antistatic agent such as surface active agent and particulate tin oxide and a matting agent such as silicon oxide and particulate PMMA incorporated therein to improve the conveyability of the image-receiving material in the recording device.

The aforementioned additives maybe incorporated not only in the back layer but also in the image-receiving layer and other layers as necessary. The kind of the additives to be used is not unequivocally limited depending on the purpose. However, if a matting agent is used, a particulate material having an average particle diameter of from 0.5 μm to 10 μm may be incorporated in the layer in an amount of from 0.5% to 80%. The antistatic agent, if used, may be properly selected from the group consisting of various surface active agents and electrically-conducting agents such that the surface resistivity of the layer is 10¹² Ω or less, preferably 10⁹ Ω or less at 23° C. and 50% RH.

As the back layer there may be used one disclosed in JP-A-2002-337468, paragraph (9119), but the invention is not limited thereto.

The aforementioned heat transfer recording material and the aforementioned image-receiving material are superposed on each other in such an arrangement that the image-forming layer of the heat transfer recording material and the image-receiving layer of the image-receiving material are opposed to each other to form a layered product which is then used to form an image.

The layered product of the heat transfer recording material with the image-receiving material can be formed by various methods. For example, the heat transfer recording material and the image-receiving material can be passed through heated rollers under pressure in such an arrangement that the image-forming layer of the heat transfer recording material and the image-receiving layer of the image-receiving material are opposed to each other to form such a laminate easily. In this case, the heating temperature is preferably 160° C. or less, more preferably 130° C. or less.

As another method for obtaining the layered product there is preferably used the aforementioned vacuum suction method.

The invention will be further described in the following examples, but the invention should not be construed as being limited thereto. The term “parts” as used hereinafter is meant to indicate “parts by weight” unless otherwise specified.

### EXAMPLE1

Preparation of Heat Transfer Recording Material W (White)

(Preparation of first back layer coating solution)

| | |
|---|---|
| Aqueous dispersion of acrylic resin | 2 parts |
| (Jurimer ET410; solid content: 20% by weight; produced | |
| by NIHON JUNYAKU CO., LTD.) | |
| Antistatic agent (aqueous dispersion of tin | 7.0 parts |
| oxide-antimony oxide) | |
| (average particle diameter: 0.1 μm; 17% by weight) | |
| Polyoxyethylene phenyl ether | 0.1 parts |
| Melamine compound | 0.3 parts |
| (Sumitix resin M-3, produced by Sumitomo Chemical Co., | |
| Ltd.) | |
| Distilled water to make | 100 parts |

(Formation of First Back Layer)

A 75 μm thick biaxially-stretched polyethylene terephthalate support (Ra of the both surfaces: 0.01 μm) was subjected to corona discharge treatment on one surface thereof (back side). The first back layer coating solution was spread over the polyethylene terephthalate support to a dry thickness of 0.03 μm, and then dried at 180° C. for 30 seconds to form a first back layer.

(Preparation of second back layer)

| | |
|---|---|
| Polyolefin | 3.0 parts |
| (Chemiperal S-120; 27% by weight; produced by Mitsui | |
| Petrochemical Co., Ltd.) | |
| Antistatic agent (aqueous dispersion of tin | 2.0 parts |
| oxide-antimony oxide) | |
| (average particle diameter: 0.1 μm; 17% by weight) | |
| Colloidal silica | 2.0 parts |
| (Snowtex C; 20% by weight; produced by Nissan Chemical | |
| Industries, Ltd.) | |
| Epoxy compound | 0.3 parts |
| (Dinacoal EX-614B, produced by Nagase Chemical Co., Ltd.) | |
| Distilled water to make | 100 parts |

(Formation of Second Back Layer)

The second back layer coating solution was spread over the first back layer to a dry thickness of 0.03 μm, and then dried at 170° C. for 30 seconds to form a second back layer.

(Formation of Light-to-Heat Conversion Layer)

(Preparation of Light-to-Heat Conversion Layer Coating Solution)

The following components were mixed with stirring by a stirrer to prepare a light-to-heat conversion layer coating solution.

| | | |
|---|---|---|
| (Formulation of light-to-heat conversion layer coating | | |
| solution) | | |
| Infrared-absorbing dye represented by formula (2): | 4.9 | parts |
| 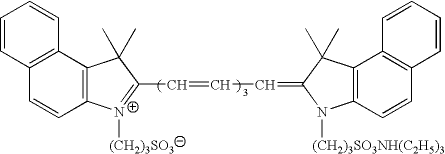 | | |
| Polyamideimide resin (15% N-methylpyrrolidone Solution) | 180 | parts |
| (“Vilomax HR-11N”, produced by TOYOBO CO., LTD.) | | |
| Particulate silicone resin | | |
| (average particle diameter: 1.2 μm) | 1.1 | parts |
| (“Tospearl 120”, produced by Toshiba Silicone Co., Ltd.) | | |
| Polyvinylpyrrolidone · styrene copolymer | 3.4 | parts |
| (ANTARA430, produced by IPS (Japan) Ltd.) | | |
| N-methylpyrrolidone (NMP) | 1,020 | parts |
| Methyl ethyl ketone | 690 | parts |
| Methanol | 10 | parts |
| Surface active agent | 0.23 | parts |
| (Megafac F-780F″, F-based surface active agent produced | | |
| by DAINIPPON INK AND CHEMICALS, | | |
| INCORPORATED) | | |

(Formation of Light-to-Heat Conversion Layer on the Surface of Support)

The aforementioned light-to-heat conversion layer coating solution was spread over one surface of a polyethylene terephthalate film (support) having a thickness of 75 μm using a wire bar. The coated material was then dried in a 120° C. oven for 2 minutes to form a light-to-heat conversion layer on the support. The light-to-heat conversion layer thus obtained was then measured for optical density (OD, absorbance) at a wavelength of 808 nm using a Type UV-240 ultraviolet spectrophotometer (produced by Shimadzu Corporation). As a result, the light-to-heat conversion layer showed an OD of 1.48. For the measurement of the thickness of the light-to-heat conversion layer, a section of the light-to-heat conversion layer was observed under scanning electron microscope. As a result, the thickness of the light-to-heat conversion layer was found to be 0.5 μm on the average. (Absorbance/thickness=2.96)

(Preparation of White Image-Forming Layer Coating Solution)

The following components were subjected to pretreatment for dispersion in the mill of a kneader while being given a shearing force with a small amount of a solvent gradually added thereto. To the dispersion was further added a solvent until the following formulation was obtained. The mixture was then subjected to sandmill dispersion for 2 hours to obtain a white pigment dispersion mother liquor.

(Formulation of white pigment dispersion mother liquor)

| | |
|---|---|
| n-Propyl alcohol | 62 parts |
| Polyvinyl butyral | 2.65 parts |
| (“Eslec B BL-SH”, produced by SEKISUI CHEMICAL CO., | |
| LTD.) | |
| Pigment dispersant | 0.35 parts |
| (“Solsperse 20000”, produced by AVECIA K. K.) | |
| Titanium oxide (detailed in Table 1) | 35 parts |

Subsequently, the following components were mixed with stirring by a stirrer to prepare a white image-forming layer coating solution.

(Formulation of white image-forming layer coating solution)

| | |
|---|---|
| n-Propyl alcohol | 1,587.4 parts |
| Methyl ethyl ketone | 577.13 parts |
| Wax-based compound | |
| (Behenic acid amide “Diamide BM”, produced by NIPPON | 5.72 parts |
| KASEI CHEMICAL CO., LTD.) | |
| (Stearic acid amide “Neutron 2”, produced by Nippon Fine | 5.72 parts |
| Chemical Co., Ltd.) | |
| (Lauric acid amide “Diamide Y”, produced by NIPPON | 5.72 parts |
| KASEI CHEMICAL CO., LTD.) | |
| (Palmitic acid amide “Diamide KP”, produced by NIPPON | 5.72 parts |
| KASEI CHEMICAL CO., LTD.) | |
| (Oleic acid amide “Diamide O-200”, produced by NIPPON | 5.72 parts |
| KASEI CHEMICAL CO., LTD.) | |
| (Erucic acid amide “Diamide L-200, produced by NIPPON | 5.72 parts |
| KASEI CHEMICAL CO., LTD.) | |
| Rosin | 80.34 parts |
| (“KE-311”, produced by Arakawa Chemical Industries, | |
| Ltd.) (Formulation: resin acid: 80 to 97%; resin acid | |
| component: abietic acid: 30 to 40%; neoabietic acid: | |
| 10 to 20%; dihydroabietic acid: 14%; tetrahydroabietic | |
| acid: 14%) | |
| White pigment dispersion mother liquor | 1,203.4 parts |
| Fluorescent brighter | 2.77 parts |
| (“Uvitex OB”, produced by Ciba Geigy Inc.) | |
| Surface active agent | 15.96 parts |
| (“Megafac F-780F”, solid content: 30%; produced by | |
| DAINIPPON INK AND CHEMICALS, | |
| INCORPORATED) | |

(Formation of White Image-Forming Layer on the Surface of Light-to-Heat Conversion Layer)

The aforementioned white image-forming layer coating solution was spread over the surface of the aforementioned light-to-heat conversion layer in 1 minute using a wire bar. The coated material was then dried in a 100° C. oven for 2 minutes to form a white image-forming layer on the light-to-heat conversion layer. During the spread of the image-forming layer, adjustment was made such that the thickness of the image-forming layer reached 1.5 μm. In this manner, a light-to-heat conversion layer and a white image-forming layer were sequentially proved on the support to prepare a heat transfer recording material W.

The physical properties of the image-forming layer thus obtained were as follows.

The surface hardness of the image-forming layer is preferably 10 g or more as measured using a sapphire needle. In some detail, the surface hardness of the image-forming layer was 200 g or more.

The contact angle of the image-forming layer with respect to water was 48.1°.

Preparation of Image-Receiving Material

A cushioning layer coating solution and an image-receiving layer coating solution having the following formulation were prepared.

1) Cushioning layer coating solution

| | |
|---|---|
| Vinyl chloride-vinyl acetate copolymer | 20 parts |
| (main binder) | |
| (“Solbine CL2”, Nisshin Chemical Co., Ltd.) | |
| Plasticizer | 10 parts |
| (“Paraplex G-40”, produced by CP. HALL. COMPANY) | |
| Surface active agent | 0.5 parts |
| (Fluorine-based; coating aid) | |
| (“Megafac F-178K”, produced by DAINIPPON INK AND | |
| CHEMICALS, INCORPORATED) | |
| Methyl ethyl ketone | 60 parts |
| Toluene | 10 parts |
| N,N-dimethylformamide | 3 parts |

2) Image-receiving layer coating solution

| | |
|---|---|
| Polyvinyl butyral | 8 parts |
| (“Eslec B BL-SH”, produced by SEKISUI CHEMICAL CO., | |
| LTD.) | |
| Antistatic agent | 0.7 parts |
| (“Sanstat 2012A”, produced by Sanyo Chemical Industries, | |
| Ltd.) | |
| Surface active agent | 0.1 parts |
| (“Megafac F-476”, produced by DAINIPPON INK AND | |
| CHEMICALS, INCORPORATED) | |
| n-Propyl alcohol | 20 parts |
| Methanol | 20 parts |
| 1-Methoxy-2-propanol | 50 parts |

Using a test coating machine, the aforementioned cushioning layer-forming coating solution was spread over a white PET support (“Lumirror #130E58; thickness: 130 μm; produced by Toray Industries, Inc.). The coat layer was then dried. Subsequently, the image-receiving layer coating solution was spread over the cushioning layer, and then dried. The spread was adjusted such that the thickness of the dried cushioning layer and image-receiving layer were about 20 μm and about 2 μm, respectively. The heat transfer recording material W thus obtained was then used in image recording by laser light as follows.

The heat transfer recording material W thus obtained was used to record an image by which it was then evaluated for properties.

Formation of Transferred Image

Using “Luxel FINALPROOF5600” (laser heat transfer printer produced by Fuji Photo Film Co., Ltd.) as a recording device, a transferred image was formed on the image-receiving material.

The image-receiving material (56 cm×79 cm) was wound on a rotary drum having a diameter of 38 cm pierced with vacuum section having a diameter of 1 mm (surface density of 1 per area of 3 cm×8 cm) to which it was then vacuum-sucked. Subsequently, the aforementioned heat transfer recording material W which had been cut to a size of 61 cm×84 cm was superposed on the image-receiving material in such an arrangement that it protruded uniformly from the image-receiving material. The two materials were bonded and superposed on each other by sucking air through the section holes while being squeezed between squeeze rollers, so as to provide a layered product. The degree of vacuum developed when the section holes were closed was −150 mmHg (approximately equal to 81.13 kPa) relative to 1 atm. While the drum was being rotated, laser light having a wavelength of 808 nm from a semiconductor laser was then converged onto the surface of the layered product on the drum in such a manner that a spot having a diameter of 7 μm was formed on the surface of the light-to-heat conversion layer. The spot was moved in the direction (subsidiary scanning) perpendicular to the direction of rotation (major scanning direction) of the rotary drum to perform laser image recording on the layered product. The laser emission conditions were as follows; As the laser light to be used in the invention there was used a two dimension array multibeam composed of a parallelogram consisting of 5 rows in the major scanning direction and 3 lines in the subsidiary scanning direction.

| | |
|---|---|
| Laser power: | 110 mW |
| Rotary speed of drum: | 380 rpm |
| Subsidiary scanning pitch: | 6.35 μm |

Ambient temperature and humidity: 20° C./40%, 23° C./50%, 26° C./65%

The diameter of the exposure drum is preferably 360 mm or more and was actually 380 mm.

The image size was 515 mm×728 mm. The resolution was 2,600 dpi.

The solid image thus recorded on the heat transfer recording material W was then retransferred onto a transparent plastic film (Melinex 709, produced by Teijin DuPont Films Japan Limited) using a heat transferring device.

As the heat transferring device there was used a transferring device having a dynamic friction coefficient of from 0.1 to 0.7 with respect to the polyethylene terephthalate consisting of the receiving table and a conveying speed of from 15 to 50 mm/sec. The Vickers hardness of the material constituting the heat roll of the heat transferring device is preferably from 10 to 100 and was actually 70.

The sample thus prepared was then evaluated for reflection density and hue and visually evaluated for coloration level, After exposure, the sample was evaluated for hue and visually evaluated for coloration level.

Measurement of Hue L*

Using X-rite, the hue L* was measured on black backing. the hue L* is preferably no less than 65 and no more than 80, more preferably no less than 72 and no more than 78.

Evaluation of Sensitivity

A solid image was recorded. The emission energy of laser light required to form a complete solid image free of blank was then determined.

Visual Evaluation of Coloration

G: No remarkable yellowing, high degree of whiteness; and

P: Remarkable yellowing

Evaluation of Dot Reproducibility

A halftone having a percent halftone of 2% was recorded. About 100 dots were then observed through a magnifier.

G: No lack of dots;

F: Some broken dots, but no lack of dots;

P: Lack of dots

Evaluation of Density Unevenness

A halftone having a percent halftone of 50% was recorded in A2 size. The halftone image was then visually observed for unevenness.

G: No unevenness;

F: Some unevenness;

P; Unevenness over the entire surface

Evaluation of Image Lack Due to Foreign Matters

A solid image was recorded in A2 size. The number of lack of images having a diameter of 1 mm or more was then counted.

G: 1 or less;.

F: 2 to 4;

P: 5 or more

### EXAMPLE 2

A white heat transfer sheet was prepared and evaluated in the same manner as in Example 1 except that the amount of the infrared-absorbing dye to be added and the spread of the light-to-heat conversion layer were changed such that the absorbance/thickness ratio of the light-to-heat conversion layer was 3.42 (1.71/0.5 μm).

### EXAMPLE 3

A white heat transfer sheet was prepared and evaluated in the same manner as in Example 1 except that the amount-of the infrared-absorbing dye to be added and the spread of the light-to-heat conversion layer were changed such that the absorbance/thickness ratio of the light-to-heat conversion layer was 3.5 (1.40/0.4 μm).

### EXAMPLE 4

A white heat transfer sheet was prepared and evaluated in the same manner as in Example 1 except that the amount of the infrared-absorbing dye to be added and the spread of the light-to-heat conversion layer were changed such that the absorbance/thickness ratio of the light-to-heat conversion layer was 2.3 (1.38/0.6 μm).

### EXAMPLE 5

A heat transfer sheet was prepared in the same manner as in Example 1 except that the particulate matting agent to be incorporated in the light-to-heat conversion layer coating solution was changed to a particulate silica having a diameter of 1.5 μm (“SeafosterKEP150”, produced by NIPPON SHOKUBAI CO., LTD.).

### EXAMPLE 6

A heat transfer sheet was prepared in the same manner as in Example 1 except that the titanium oxide to be incorporated in the image-forming layer was changed to rutile alumina-coated titanium oxide (“JR405”, produced by TAYCA CORPORATION).

### EXAMPLE 7

A heat transfer sheet was prepared in the same manner as in Example 1 except that the titanium oxide to be incorporated in the image-forming layer was changed to anatase titanium oxide (“JA1”, produced by TAYCA CORPORATION).

### EXAMPLE 8

A heat transfer sheet was prepared in the same manner as in Example 1 except that the light-to-heat conversion layer was free of “ANTARA430”.

### EXAMPLE 9

A heat transfer sheet was prepared in the same manner as in Example 1 except that “ANTARA430” to be incorporated in the light-to-heat conversion layer was replaced by a styrene/acrylic copolymer (“Johncryl 611”, produced by Johnson Polymer Co., Ltd.).

### EXAMPLE 10

A heat transfer sheet was prepared in the same manner as in Example 1 except that 6.8 parts of a 20% solution of N-methylpyrrolidone (“Rikacoat SN20”, produced by New Japan Chemical Co., Ltd.) were used instead of “Vilomax HR-11NN” to be incorporated in the light-to-heat conversion layer.

### EXAMPLE 11

A heat transfer sheet was prepared in the same manner as in Example 1 except that the image-forming layer was free of “Uvitex-OB”.

### COMPARATIVE EXAMPLE 1

A heat transfer sheet was prepared in the same manner as in Example 1 except that the light-to-heat conversion layer was free of “Tospearl 120”.

### COMPARATIVE EXAMPLE 2

A heat transfer sheet was prepared in the same manner as in Example 1 except that a particulate silica having a particle diameter of 0.5 μm was incorporated in the light-to-heat conversion layer instead of “Tospearl 120”.

### COMPARATIVE EXAMPLE 3

A heat transfer sheet was prepared in the same manner as in Example 1 except that a particulate PMMA having a particle diameter of 5 μm (“MX500”, produced by Soken Chemical & Engineering Co., Ltd.) was incorporated in the light-to-heat conversion layer instead of “Tospearl 120”.

TABLE 1

| | | | | In-plane | Image lack | |
|---|---|---|---|---|---|---|
| | | | | uniformity of | due to | |
| | | | Sensitivity | transfer | foreign | Dot |
| | Coloration | L* | (mJ/cm²) | density | matters | reproducibility |
| Example 1 | G | 76 | 430 | G | G | G |
| Example 2 | G | 76 | 430 | G | G | G |
| Example 3 | F | 74 | 400 | G | G | G |
| Example 4 | G | 76 | 600 | G | G | G |
| Example 5 | G | 76 | 430 | G | G | G |
| Example 6 | G | 70 | 430 | G | G | G |
| Example 7 | G | 68 | 430 | G | G | G |
| Example 8 | F | 74 | 430 | G | G | G |
| Example 9 | G | 76 | 430 | F | G | G |
| Example 10 | G | 74 | 500 | G | G | G |
| Example 11 | F | 75 | 430 | G | G | G |
| Comparative | P | 74 | 425 | P | P | G |
| Example 1 | | | | | | |
| Comparative | F | 76 | 430 | F | P | G |
| Example 2 | | | | | | |
| Comparative | P | 74 | 590 | G | G | P |
| Example 3 | | | | | | |

As can be seen in Table 1 above, the inventive examples exhibit a high hiding power, little yellowish tint, a high degree of whiteness, little fading due to indoor exposure, a high recording density and a good image quality.

### EXAMPLE 12

Preparation of Heat Transfer Recording Material W (White)

(Formation of Back Layer)

(Preparation of first back layer coating solution)

| | |
|---|---|
| Aqueous dispersion of acrylic resin | 2 parts |
| (Jurimer ET410; solid content: 20% by weight; produced | |
| by NIHON JUNYAKU CO., LTD.) | |
| Antistatic agent (aqueous dispersion of tin | 7.0 parts |
| oxide-antimony oxide) | |
| (average particle diameter: 0.1 μm; 17% by weight) | |
| Polyoxyethylene phenyl ether | 0.1 parts |
| Melamine compound | 0.3 parts |
| (Sumitix resin M-3, produced by Sumitomo Chemical Co., | |
| Ltd.) | |
| Distilled water to make | 100 parts |

(Formation of First Back Layer)

A 75 μn thick biaxially-stretched polyethylene terephthalate support (Ra of the both surfaces; 0.01 μm) was subjected to corona discharge treatment on one surface thereof (back side). The first back layer coating solution was spread over the polyethylene terephthalate support to a dry thickness of 0.03 μm, and then dried at 180° C. for 30 seconds to form a first back layer.

(Preparation of second back layer)

| | |
|---|---|
| Polyolefin | 3.0 parts |
| (Chemiperal S-120; 27% by weight; produced by Mitsui | |
| Petrochemical Co., Ltd.) | |
| Antistatic agent (aqueous dispersion of tin | 2.0 parts |
| oxide-antimony oxide) | |
| (average particle diameter: 0.1 μm; 17% by weight) | |
| Colloidal silica | 2.0 parts |
| (Snowtex C; 20% by weight; produced by Nissan Chemical | |
| Industries, Ltd.) | |
| Epoxy compound | 0.3 parts |
| (Dinacoal EX-614B, produced by Nagase Chemical Co., Ltd.) | |
| Distilled water to make | 100 parts |

(Formation of Second Back Layer)

The second back layer coating solution was spread over the first back layer to a dry thickness of 0.03 μm, and then dried at 170° C. for 30 seconds to form a second back layer.

(Formation of Light-to-Heat Conversion Layer)

(Preparation of Light-to-Heat Conversion Layer Coating Solution 1)

The following components were mixed with stirring by a stirrer to prepare a light-to-heat conversion layer coating solution 1.

| | | |
|---|---|---|
| (Formulation of light-to-heat conversion layer coating | | |
| solution 1 | | |
| Infrared-absorbing dye represented by the following | 4.9 | parts |
| structural formula: | | |
| 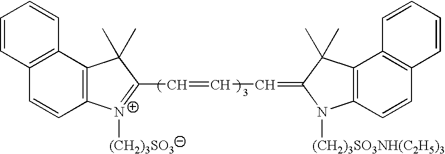 | | |
| Polyamideimide resin (15% N-methylpyrrolidone solution) | 180 | parts |
| (“Vilomax HR-11N”, produced by TOYOBO CO., LTD.) | | |
| 1.5 μ Particulate silicone resin | 1.11 | parts |
| (“Tospearl 120”, produced by Toshiba Silicone Co., Ltd.) | | |
| Polyvinyl pyrrolidone-styrene copolymer | 3.41 | parts |
| (“Anthala430”, produced by ISP Co., Ltd.) | | |
| N-methylpyrrolidone (NMP) | 1,023 | parts |
| Methyl ethyl ketone | 690 | parts |
| Methanol | 98 | parts |
| Surtace active agent | 0.23 | parts |
| (Megafac F-780F″, F-based surface active agent produced | | |
| by DAINIPPON INK AND CHEMICALS, | | |
| INCORPORATED) | | |

(Formation of Light-to-Heat Conversion Layer on the Surface of Support)

The aforementioned light-to-heat conversion layer coating solution was spread over one surface of a polyethylene terephthalate film (support) having a thickness of 75 μm using a wire bar. The coated material was then dried in a 120° C. oven for 2 minutes to form a light-to-heat conversion layer on the support. The light-to-heat conversion layer thus obtained was then measured for optical density (OD, absorbance) at a wavelength of 808 nm using a Type UV-240 ultraviolet spectrophotometer (produced by Shimadzu Corporation). As a result, the light-to-heat conversion layer showed an OD of 1.71. For the measurement of the thickness of the light-to-heat conversion layer, a section of the light-to-heat conversion layer was observed under scanning electron microscope. As a result, the thickness of the light-to-heat conversion layer was found to be 0.60 μm on the average.

(Formation of Image-Forming Layer on the Surface of Light-to-Heat Conversion Layer)

The following white image-forming layer coating solution was spread over the surface of the aforementioned light-to-heat conversion layer in 1 minute using a wire bar. The coated material was then dried in a 100° C. oven for 2 minutes to form a white image-forming layer on the light-to-heat conversion layer.

The thickness of the image-forming layer of the heat transfer recording material W thus obtained was 1.50 μm.

(Formulation of white pigment dispersion mother liquor)

| | |
|---|---|
| Polyvinyl butyral | 2.7 parts |
| (“Eslec B BL-SH”, produced by SEKISUI CHEMICAL | |
| CO., LTD.) | |
| Rutile titanium oxide | 35.0 parts |
| (“JR805”, produced by TAYCA CORPORATION, mass | |
| average particle diameter 0.29 μm) | |
| Dispersing aid | 0.35 parts |
| (“Solsperse 20000”, produced by AVECIA K.K.) | |
| n-Propyl alcohol | 62.0 parts |

(Formulation of white image-forming layer coating solution)

| | |
|---|---|
| White pigment dispersion mother liquor | 1,203 parts |
| 2,5-Bis[2-(5-t-butylbenzooxazolyl)]thiophene | 2.8 parts |
| (fluorescent brightener Uvitex OB, produced by Ciba | |
| Specialty Chemicals Co., Ltd.) | |
| * Wax-based compound | |
| (Stearic acid amide “Neutron 2”, produced by Nippon Fine | 5.7 parts |
| Chemical Co., Ltd.) | |
| (Behenic acid amide “Diamide BM”, produced by | 5.7 parts |
| NIPPONKASEI CHEMICAL CO., LTD.) | |
| (Lauric acid amide “Diamide Y”, produced by NIPPON | 5.7 parts |
| KASEI CHEMICAL CO., LTD.) | |
| (Palmitic acid amide “Diamide KP”, produced by NIPPON | 5.7 parts |
| KASEI CHEMICAL CO., LTD.) | |
| (Erucic acid amide “Diamide L-200, produced by NIPPON | 5.7 parts |
| KASEI CHEMICAL CO., LTD.) | |
| (Oleic acid amide “Diamide O-200”, produced by NIPPON | 5.7 parts |
| KASEI CHEMICAL CO., LTD.) | |
| Rosin | 80.3 parts |
| (“KE-311”, producedbyArakawaChemicalIndustries, Ltd.) | |

(Formulation: resin acid: 80 to 97%; resinacidcomponent:
abietic acid: 30 to 40%; neoabietic acid: 10 to 20%;
dihydroabietic acid: 14%; tetrahydroabietic acid: 14%)

| | |
|---|---|
| Surface active agent | 16 parts |
| (“Megafac F-780F”, solid content: 30%, produced by | |
| DAINIPPON INK AND CHEMICALS, | |
| INCORPORATED) | |
| n-Propyl alcohol | 1,600 parts |
| Methyl ethyl ketone | 580 parts |

Preparation of Image-Receiving Material

A cushioning layer coating solution and an image-receiving layer coating solution having the following formulation were prepared.

1) Cushioning layer coating solution

| | |
|---|---|
| Vinyl chloride-vinyl acetate copolymer | 20 parts |
| (main binder) | |
| (“Solbine CL2”, Nisshin Chemical Co., Ltd.) | |
| Plasticizer | 10 parts |
| (“Paraplex G-40”, produced by CP. HALL. COMPANY) | |
| Surface active agent | 0.5 parts |
| (Fluorine-based; coating aid) | |
| (“Megafac F-178K”, produced by DAINIPPON INK AND | |
| CHEMICALS, INCORPORATED) | |
| Methyl ethyl ketone | 60 parts |
| Toluene | 10 parts |
| N,N-dimethylformamide | 3 parts |

2) Image-receiving layer coating solution

| | |
|---|---|
| Polyvinyl butyral | 8 parts |
| (“Eslec B BL-SH”, produced by SEKISUI CHEMICAL CO., | |
| LTD.) | |
| Antistatic agent | 0.7 parts |
| (“Sanstat 2012A”, produced by Sanyo Chemical Industries, | |
| Ltd.) | |
| Surface active agent | 0.1 parts |
| (“Megafac F-476”, produced by DAINIPPON INK AND | |
| CHEMICALS, INCORPORATED) | |
| n-Propyl alcohol | 20 parts |
| Methanol | 20 parts |
| 1-Methoxy-2-propanol | 50 parts |

Using a test coating machine, the aforementioned cushioning layer-forming coating solution was spread over a white PET support (“Lumirror #130E58; thickness: 130 μm; produced by Toray Industries, Inc.). The coat layer was then dried. Subsequently, the image-receiving layer coating solution was spread over the cushioning layer, and then dried. The spread was adjusted such that the thickness of the dried cushioning layer and image-receiving layer were about 20 μm and about 2 μm, respectively. The heat transfer recording material W thus obtained was then used in image recording by laser light as follows.

### EXAMPLE 13

The procedure of Example 12 was followed except that the thickness of the light-to-heat conversion layer was adjusted such that the absorbance thereof at a wavelength of 808 nm was 1.48. The thickness of the light-to-heat conversion layer was 0.50 μm.

### EXAMPLE 14

The procedure of Example 12 was followed except that the thickness of the light-to-heat conversion layer was adjusted such that the absorbance thereof at a wavelength of 808 nm was 1.15. The thickness of the light-to-heat conversion layer was 0.39 μm.

### EXAMPLE 15

The procedure of Example 12 was followed except that a light-to-heat conversion layer coating solution 2 comprising an infrared-absorbing dye as mentioned below instead of the compound used in Example 12 and the thickness of the light-to-heat conversion layer was adjusted. The thickness of the light-to-heat conversion layer was adjusted such that the absorbance at a wavelength of 808 nm was 1.71. The thickness of the light-to-heat conversion layer was 0.63 μm.

| | |
|---|---|
| Infrared-absorbing dye | 4.85 parts |
| NK-2014(produced by Nihon Kanko Shikiso K.K.) | |

### COMPARATIVE EXAMPLES 4 AND 5

The procedure of Example 12 was followed except that the thickness of the light-to-heat conversion layer was adjusted. The absorbance of Comparative Examples 4 and 5 at a wavelength of 808 nm were 2.20 and 0.87, respectively. The thickness of the light-to-heat conversion layer of Comparative Examples 4 and 5 were 0.77 μm and 0.30 μm, respectively. cl COMPARATIVE EXAMPLES 6 TO 9

The procedure of Example 12 was followed except that a light-to-heat conversion layer coating solution 3 obtained by changing the infrared-absorbing dye to be incorporated in the light-to-heat conversion layer coating solution 1 as follows and the thickness of the light-to-heat conversion layer was adjusted as follows.

| | |
|---|---|
| Infrared-absorbing dye (same as in Example 1) | 6.40 parts |

In Comparative Examples 6 to 9, the thickness of the light-to-heat conversion layer was adjusted such that the absorbance at a wavelength of 808 nm was 1.63, 1.37, 1.09 and 0.78, respectively. The thickness of the light-to-heat conversion layer of Comparative Examples 6 to 9 were 0.47 μm, 0.40 μm, 0.31 μn and 0.24 μm, respectively.

### COMPARATIVE EXAMPLES 10 TO 13

The procedure of Example 12 was followed except that a light-to-heat conversion layer coating solution 4 obtained by changing the infrared-absorbing dye to be incorporated in the light-to-heat conversion layer coating solution 1 as follows and the thickness of the light-to-heat conversion layer was adjusted as follows.

| | |
|---|---|
| Infrared-absorbing dye (same as in Example 1) | 8.15 parts |

In Comparative Examples 10 to 13, the thickness of the light-to-heat conversion layer was adjusted such that the absorbance at a wavelength of 808 nm was 1.58, 1.30, 0.97 and 0.75, respectively. The thickness of the light-to-heat conversion layer of Comparative Examples 10 to 13 were 0.39 μm, 0.33 μm, 0.26 μm and 0.19 μm, respectively.

### COMPARATIVE EXAMPLES 14 TO 17

The procedure of Example 12 was followed except that a light-to-heat conversion layer coating solution 5 obtained by changing the infrared-absorbing dye to be incorporated in the light-to-heat conversion layer coating solution 1 as follows and the thickness of the light-to-heat conversion layer was adjusted as follows.

| | |
|---|---|
| Infrared-absorbing dye (same as in Example 1) | 2.43 parts |

In Comparative Examples 14 to 17, the thickness of the light-to-heat conversion layer was adjusted such that the absorbance at a wavelength of 808 nm was 1.91, 1.70, 1.37 and 1.08, respectively. The thickness of the light-to-heat conversion layer of Comparative Examples 14 to 17 were 1.19 μm, 1.00 μm, 0.79 μm and 0.60 μm, respectively.

The properties of the aforementioned image-receiving material, were then evaluated as follows.

Formation of Transferred Image

Using “LuxelFINALPROOF5600” (laser heat transfer printer produced by Fuji Photo Film Co., Ltd.), a white solid image was formed on the image-receiving material through the aforementioned heat transfer recording material W. In some detail, recording was effected at 23° C. and 50% RH with an energy of 434 mJ/cm² as follows.

The image-receiving material (56 cm×79 cm) thus prepared was wound on a rotary drum having a diameter of 38 cm pierced with vacuum section having a diameter of 1 mm (surface density of 1 per area of 3 cm×8 cm) to which it was then vacuum-sucked. Subsequently, the aforementioned heat transfer recording material K which had been cut to a size of 61 cm×84 cm was superposed on the image-receiving material in such an arrangement that it protruded uniformly from the image-receiving material. The two materials were bonded and superposed on each other by sucking air through the section holes while being squeezed between squeeze rollers, so as to provide a layered product. The degree of vacuum developed when the section holes were closed was −150 mmHg (approximately equal to 81.13 kPa) relative to 1 atm. While the drum was being rotated, laser light having a wavelength of 808 nm from a semiconductor laser was then converged onto the surface of the layered product on the drum in such a manner that a spot having a diameter of 7 μm was formed on the surface of the light-to-heat conversion layer. The spot was moved in the direction (subsidiary scanning) perpendicular to the direction of rotation (major scanning direction) of the rotary drum to perform laser image recording on the layered product. The laser emission conditions were as follows. As the laser light to be used in the invention there was used a two dimension array multibeam composed of a parallelogram consisting of 5 rows in the major scanning direction and 3 lines in the subsidiary scanning direction.

Rotary speed of drum: 500 rpm

Subsidiary scanning pitch: 6.35 μm

The image size was 515 mm×728 mm. The resolution was 2,600 dpi.

Using a type FPL760T laminator (produced by Fuji Photo Film Co., Ltd.), the aforementioned solid image and image-receiving layer were then retransferred onto a transparent plastic film (Melinex 709, 50 μm thickness produced by Teijin DuPont Films Japan Limited),

The image thus obtained was then evaluated as follows. The results are set forth in Table 2 below.

1) Coloration

The solid area of the printer matter was measured for L*a*b* under the measuring condition of D50² using X-rite938 (produced by X-rite 938 Co., Ltd.). The smaller b* is, the less is the yellowish component produced by the decomposition products of infrared-absorbing dye to advantage.

For the evaluation of hue, the following criterion was used.

G: Desirable whiteness (b*≦5.0);

P: Undesirable yellowish tint visually observed (b*≧5.6);

F: 5.6<b*<5.6

2) Image Quality

P: Stripes observed left untransferred to solid area and halftone area;

G: No stripes observed left untransferred to solid area and halftone area, good halftone

3) General Judgment

G: Good in both “coloration” and “image quality”;

F: Good in either “coloration” or “image quality” but fair in the other;

TABLE 2

| | Light-to-heat | | | | | | | |
|---|---|---|---|---|---|---|---|---|
| | conversion layer | | | | | | Image | General |
| | coating solution | A/X | A | X | b* | Hue | quality | judgment |
| Example 12 | Coating Solution 1 | 2.9 | 1.71 | 0.60 | 4.6 | G | G | G |
| Example 13 | Coating solution 1 | 3.0 | 1.48 | 0.50 | 4.9 | G | G | G |
| Example 14 | Coating solution 1 | 2.9 | 1.15 | 0.39 | 4.6 | G | G | G |
| Example 15 | Coating solution 2 | 2.7 | 1.71 | 0.63 | 5.5 | F | G | F |
| Comparative | Coating solution 1 | 2.9 | 2.20 | 0.77 | 4.5 | G | P | P |
| Example 4 | | | | | | | | |
| Comparative | Coating solution 1 | 2.9 | 0.87 | 0.30 | 4.2 | G | P | P |
| Example 5 | | | | | | | | |
| Comparative | Coating solution 3 | 3.5 | 1.63 | 0.47 | 5.7 | P | G | p |
| Example 6 | | | | | | | | |
| Comparative | Coating solution 3 | 3.4 | 1.37 | 0.40 | 5.7 | P | G | P |
| Example 7 | | | | | | | | |
| Comparative | Coating solution 3 | 3.5 | 1.09 | 0.31 | 5.2 | F | P | P |
| Example 8 | | | | | | | | |
| Comparative | Coating solution 3 | 3.3 | 0.78 | 0.24 | 4.3 | G | P | P |
| Example 9 | | | | | | | | |
| Comparative | Coating solution 4 | 4.1 | 1.58 | 0.39 | 6.5 | P | G | P |
| Example 10 | | | | | | | | |
| Comparative | Coating solution 4 | 3.9 | 1.30 | 0.33 | 6.3 | P | G | P |
| Example 11 | | | | | | | | |
| Comparative | Coating solution 4 | 3.7 | 0.97 | 0.26 | 5.6 | P | P | P |
| Example 12 | | | | | | | | |
| Comparative | Coating solution 4 | 3.9 | 0.75 | 0.19 | 4.2 | G | P | P |
| Example 13 | | | | | | | | |
| Comparative | Coating solution 5 | 1.6 | 1.91 | 1.19 | 3.0 | G | P | P |
| Example 14 | | | | | | | | |
| Comparative | Coating solution 5 | 1.7 | 1.70 | 1.00 | 2.8 | G | P | P |
| Example 15 | | | | | | | | |
| Comparative | Coating solution 5 | 1.7 | 1.37 | 0.79 | 2.8 | G | P | P |
| Example 16 | | | | | | | | |
| Comparative | Coating solution 5 | 1.8 | 1.08 | 0.60 | 2.5 | G | P | P |
| Example 17 | | | | | | | | |

In accordance with the invention, a heat transfer recording material capable of forming an image having a desirable hue as white image and a good image quality can be obtained.

1. A heat transfer recording material, which comprises:
a support;
a light-to-heat conversion layer comprising a light-to-heat conversion material and a matting agent, the matting agent having an average particle diameter of more than 0.5 μm and less than 5 μm; and
an image-forming layer comprising a titanium oxide.

2. The heat transfer recording material according to claim 1, wherein the matting agent comprises a particulate silicone resin.

3. The heat transfer recording material according to claim 1, wherein the titanium oxide is a rutile titanium oxide.

4. The heat transfer recording material according to claim 1, wherein the titanium oxide has a surface coated with an alumina and a silica.

5. The heat transfer recording material according to claim 1, wherein the light-to-heat conversion layer comprises at least one of a vinyl pyrrolidone homopolymaer and a vinyl pyrrolidone copolymer.

6. The heat transfer recording material according to claim 5, wherein the vinyl pyrrolidone copolymer comprises a vinyl pyrrolidone moiety in an amount of 50 mol-% or more.

7. The heat transfer recording material according to claim 5, wherein the vinyl pyrrolidone copolymer is a copolymer of a vinyl pyrrolidone and a styrene.

8. The heat transfer recording material according to claim 1, wherein the light-to-heat conversion layer comprises a polyamideimide resin.

9. The heat transfer recording material according to claim 1, wherein the light-to-heat conversion layer has a absorbance A of from 1.0 to 2.0 at a wavelength of 808 nm, and the light-to-heat conversion layer has a ratio A/X of the absorbance A to a thickness X of the light-to-heat conversion layer of from 2.5 to 3.2.

10. The heat transfer recording material according to claim 1, wherein the light-to-heat conversion material is an infrared-absorbing dye represented by formula (1): 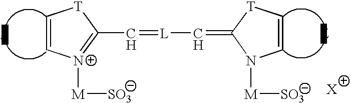
wherein Z represents an atomic group which forms a benzene ring, naphthalene ring or heterocyclic aromatic ring:
T represents —O—, —S—, —Se—, —N(R¹)—, —C(R²)(R³)— or —C(R⁴)═C(R⁵)—, wherein R¹, R² and R³ each independently represents an alkyl group, an alkenyl group or an aryl group; and R⁴ and R⁵ each independently represents a hydrogen atom, a halogen atom, an alkyl group, an aryl group, an alkoxy group, an aryloxy group, a carboxyl group, an acyl group, an acylamino group, a carbamoyl group, a sulfamoyl group or a sulfonamide group;
L represents a trivalent connecting group, wherein 5 or 7 methine groups are connected with a conjugated double bond;
M represents a divalent connecting group; and
X⁺ represents a cation.

11. The heat transfer recording material according to claim 10, wherein the infrared-absorbing dye is a dye represented

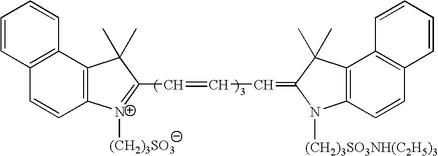

12. The heat transfer recording material according to claim 1, wherein the image-forming layer comprises a fluorescent brightener.

13. A heat transfer recording material, which comprises: a support; a light-to-heat conversion layer comprising a light-to-heat conversion material, the light-to-heat conversion material absorbing a laser light to generate a heat; and an image-forming layer,
the light-to-heat conversion layer has a absorbance A of from 1.0 to 2.0 at a peak wavelength of the laser light, and the light-to-heat conversion layer has a ratio A/X of the absorbance A to a thickness X of the light-to-heat conversion layer of from 2.5 to 3.2.

14. The heat transfer recording material according to claim 13, wherein the light-to-heat conversion material comprises an infrared-absorbing dye represented by formula (1): 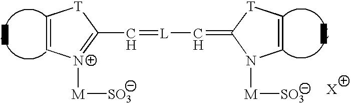
wherein Z represents an atomic group which forms a benzene ring, naphthalene ring or heterocyclic aromatic ring;
T represents —O—, —S—, —Se—, —N(R¹)—, —C(R²)(R³)— or —C(R)═C(R⁵)—, wherein R¹, R² and R³ each independently represents an alkyl group, an alkenyl group or an aryl group; and R⁴ and R⁵ each independently represents a hydrogen atom, a halogen atom, an alkyl group, an aryl group, an alkoxy group, an aryloxy group, a carboxyl group, an acyl group, an acylamino group, a carbamoyl group, a sulfamoyl group or a sulfonamide group;
L represents a trivalent connecting group, wherein 5 or 7 methine groups are connected with a conjugated double bond;
M represents a divalent connecting group; and
X⁺ represents a cation.

15. The heat transfer recording material according to claim 14, wherein the infrared-absorbing dye is a dye represented by formula (2):

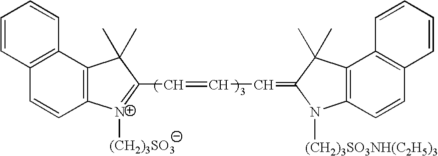

16. The heat transfer recording material according to claim 13, wherein the image-forming layer comprises a titanium oxide.

17. The heat transfer recording material according to claim 16, wherein the titanium oxide is a rutile titanium oxide.

18. The heat transfer recording material according to claim 16, wherein the titanium oxide has a surface coated with an alumina and a silica.

19. The heat transfer recording material according to claim 13, wherein the peak wavelength of the laser light is 808 nm.
